(19) United States
(12) Patent Application Publication
(10) Pub. No.: US 2002/0152323 A1
(43) Pub. Date: Oct. 17, 2002

(54) Transferring apparatus and transfer controlling method

(76) Inventors: Yasuhiro Ono, Kawasaki (JP); Kiyoshi Sukegawa, Kawasaki (JP); Tetsuya Tsuboi, Kawasaki (JP)

Correspondence Address: Rosenman & Colin LLP, 575 Madison Avenue, New York, NY, 10022-2585, US

(21) Appl. No.: 09/962,545

(22) Filed: Sep. 24, 2001

(30) Foreign Application Priority Data
Apr. 17, 2001 (JP) 2001-118848

(51) Int. Cl. G06F 15/16

(52) U.S. Cl. 709/245; 709/236

(57) ABSTRACT

An IP data transmission technique on ATM. A bridge-hub apparatus comprises an input/output unit inputting/outputting a frame including a MAC address by which a terminal connected to a network can be identified, a upper identification data holding unit holding own IP address of the bridge-hub apparatus connected to the network, a lower identification data holding unit holding own MAC address of the bridge-hub apparatus connected to the network, and a lower layer frame processing unit transferring a frame to either own apparatus's side or other terminals' side connected to the network on the basis of own IP address and own MAC address, thereby switching at high speed.

### BACKGROUND OF THE INVENTION

(1) Field of the Invention

The present invention relates to a transferring apparatus and a transfer controlling method suitable for use, for example, in a bridge-hub apparatus having a bridging function and a routing function.

(2) Description of the Related Art

A network transmitting IP (Internet protocol) datagram generally comprises a bridge apparatus, a hub apparatus, abridge-hub apparatus, a routing apparatus, etc. along with a personal computer. Among these apparatuses, a frame and IP datagram are repeated.

Meanwhile, construction of ATM (Asynchronous Transfer Mode) networks capable of high-speed, large-volume data transfer is active in recent years. In the ATM network, each frame or IP datagram is encapsulated in an ATM cell, a virtual channel and a virtual path representing a destination are given to the ATM cell, the ATM cell is then transmitted. When original data is IP datagram, it is particularly called IP transmission over ATM (IP over ATM).

The above bridging apparatus is an apparatus having the bridging function. In concrete, the bridging apparatus is one of repeating apparatuses interconnecting networks, which discriminates a MAC address (physical address) of a terminal in the same network or in a different network at MAC (Media Access Control) Layer in Layer 2 (data link layer; hereinafter used to signify Layer 2 level), and repeats a frame.

Additionally, the bridging apparatus has an address filtering (hereinafter referred as filtering, occasionally) function. The filtering function is to identify a MAC address included in a received frame to transfer the frame to another route (transmission route). Since the bridging apparatus mainly processes at Layer 2 or below, the bridging apparatus cannot express a MAC address and an IP address, thus not having these addresses.

The MAC address functions as identification data to identify a terminal in a network at MAC layer. The IP address functions as identification data to identify a terminal in a network at IP layer. Namely, the MAC address is lower layer identification data, whereas the IP address is upper layer identification data.

The hub apparatus is an apparatus having a hub function. In concrete, the hub function is to output a frame received from one port (physical port) to all the other ports. The hub apparatus is provided with table data showing a relationship between a MAC address and a port name to identify a MAC address of a terminal with the table data. The hub apparatus allows only data having a specific address to pass through to another route.

Further, since the hub apparatus processes mainly at Layer 2 or below, the hub apparatus does not have its own MAC address and IP address.

The bridge-hub apparatus is an apparatus in which the bridge apparatus and the hub apparatus are collected (put together).

Each of these apparatuses is to repeat mainly data at Layer 2 or below. Data at not lower than Layer 3 is processed by a routing apparatus (router).

The routing apparatus is an apparatus having a routing function (IP routing). The routing function is to set a route suitable to transfer among a plurality of routes leading to other network systems or gateway servers.

In other words, the routing function is mainly a function of distributing IP datagram at Layer 3. In concrete, the routing apparatus does not manage a transmission source MAC address at Layer 2 like the bridge-hub apparatus, but routes only IP datagram.

Next, data transmitted/received by the bridge-hub apparatus and the routing apparatus, and a MAC address and an IP address will be described with reference to FIGS. 18(a) and 18(b).

FIG. 18(a) is a diagram showing an example of format for IP addresses, whereas FIG. 18(b) is a diagram showing an example of format for MAC addresses. IP datagram shown in FIG. 18(a) is composed of about 1500 bytes, which includes a transmission source IP address and a transmission destination IP address (destination IP address) each of 32 bits. A frame shown in FIG. 18(b) includes a transmission destination MAC address (destination MAC address) and a transmission source MAC address. The MAC address is generally of 48 bits.

Namely, elements conFIGuring LAN (Local Area Network), and terminals connected to a network are identified with MAC addresses and IP addresses.

Next, terms relating to frame and address will be described.

An object of processing not upper than Layer 2 is referred as a frame. Frame signifies, for example, Ethernet frame. When discriminated from IP datagram, the frame is referred as MAC frame. A MAC address and an IP address of a terminal or an apparatus receiving a frame or IP datagram, or an apparatus or terminal itself are sometimes referred as own MAC address and own IP address, respectively.

A relationship between Layer 2 and Layer 3 is a relationship between a lower layer and a upper layer. A MAC frame and IP datagram are in a relationship between a lower layer frame and a upper layer frame.

With respect to a DSU (Digital Service Unit) in which the bridge-hub function and the routing function are integrated (conFIGured into one unit), an ADSL (Asymmetric Digital Subscriber Line) modem in an ATM network and a filtering function possessed by the ADSL modem will be described by way of the ADSL modem with reference to FIG. 15. ADSL signifies a high-speed transmission system having asymmetric transmission/reception which transmits data of 1.5 to 9.2 Mbps (megabit per second) downstream using a metallic line used for a subscriber telephone line.

FIG. 15 is a diagram showing a structure of an ATM cell transmission system. The system 200 shown in FIG. 15 is a network system transferring data, which comprises terminals 10a, 10b, . . . , and 10n (n is a natural number not less than one), a user's premise 60, a telephone central office 71 and the Internet 62. The user's premise is a house or an office of a subscriber, a general individual, a person who uses the house or the office for business or an operator for business. The user's premise 60 includes a bridge-hub apparatus (ADSL modem) 60b, and a bridge controllable terminal 60a which controls the bridge-hub apparatus (ADSL modem) 60b.

Each of the terminals 10a, 10b, . . . , and 10n is a personal computer having a MAC address a, b, . . . , or n'. Incidentally, each of a, b, . . . , and n' is a hexadecimal number of 48 bits, for example.

The bridge-hub apparatus 60 converts data received over a line 60d into an ATM cell, and transmits the ATM cell to the telephone central office 71. Besides, the bridge-hub apparatus 60b receives an ATM cell from the telephone central office 71, extracts IP datagram or a frame from the received ATM cell, and transmits it to the terminal 10a, 10b, . . . or 10n.

The bridge-hub apparatus 60b is used as a routing apparatus when set routing. When set bridging, the bridge-hub apparatus 60b is used as a bridging apparatus. These functions are realized by a changeover by, for example, an external switch.

A frame transmitted from, for example, the terminal 10a is converted into an ATM cell by the bridge-hub apparatus 60b. The ATM cell is transmitted over the line 60d, ATM-terminated by a upper opposite apparatus 61b, and transmitted to the bridge controllable terminal 61 and an access routing apparatus (access router) 61c. The data is then transmitted from the access routing apparatus 61c to an information server 62b over the Internet 62 (refer to a part denoted as flow of data).

Data transmitted from the information server 62b is transmitted in the opposite stream over the Internet 62, and ATM-terminated by the bridge-hub apparatus 60b. A frame or IP datagram of the data is repeated to the terminal 10a. Each of the terminal 10b, 10c, . . . and 10n performs similarly to the terminal 10a.

In the system 200, data is transmitted/received between the same subnetwork 20 and a different subnetwork 21.

As above, the data is converted from IP datagram to an ATM cell, and vice versa. Data outputted from the terminal 10a is transmitted at very high speed over the line 60d.

Next, a layer structure of the bridge-hub apparatus 60b will be schematically described with reference to FIGS. 16 and 17.

FIG. 16 is a diagram for illustrating a schematic layer structure of the bridge-hub apparatus 60b. The bridge-hub apparatus 60b shown in FIG. 16 comprises a transmitting/receiving unit 81, a MAC processing unit 82, an IP processing unit 83, an application processing unit 84, and a learning table (MAC address learning table) 61.

The bridge-hub apparatus 60b filters a received frame, besides transmitting/receiving a frame and performing a terminating process. In concrete, the bridge-hub apparatus 60b fragments (divides) data to be transmitted, attaches a header including a destination to the fragmented data to generate a frame. Besides, the bridge-hub apparatus 60b assembles received frames, removes unnecessary headers, and generates one piece of IP datagram on the basis of each divided fragment.

The transmitting/receiving unit 81 corresponds to Layer 1, which has a port P1 (port 1), a port P2 (port 2), . . . , and a port Pn (port n). The MAC processing unit 82 mainly corresponds to Layer 2, which processes a MAC address, and uses the learning table 61.

FIG. 17 is a diagram for illustrating the learning table 61. In the learning table 61 shown in FIG. 17, each of the ports (port numbers) P1-Pn (n is a natural number not less than one) is related with a MAC address (MAC address information), and held. Owing to the learning table 61, the bridge-hub apparatus 60b can find a type and a place of each port.

In FIG. 16, the IP processing unit 83 mainly corresponds to Layer 3, which processes IP datagram. The application processing unit 84 corresponds to Layer 4 to Layer 7, which mainly processes upper applications.

When the port P1 of the bridge-hub apparatus 60b having the structure shown in FIG. 16 receives a MAC frame addressed to the terminal 10b from the terminal 10a, the MAC processing unit 82 sets a MAC address “a” at the port P1 in the learning table 61 (refer to FIG. 17), and retrieves presence of a MAC address “n'” in the learning table 61.

When the MAC address “n'” of the port Pn in the learning table 61 is in agreement, the MAC processing unit 82 transfers the MAC frame transmitted from the terminal 10a to the port Pn.

It is thereby possible to prevent occurrence of congestion. When there is not the MAC address “n'” in address information of the learning table 61, the MAC processing unit 82 transfers the MAC address received by the port P1 to the ports P2-Pn.

Since the bridge-hub apparatus 60b does not have a MAC address and an IP address, the IP datagram does not reach the IP processing unit 83 shown in FIG. 16.

When the learning table 61 is in the initial state, nothing is set in the item of MAC address and the item of port. For this, the received MAC frame is transferred to all the ports P1-Pn excepting the receiving port P1.

When the destination MAC address is a broadcast address for broadcasting, the received MAC frame is transferred to all the ports excepting a port having received the received MAC frame irrespective of contents held in the learning table 61.

Whereby, occurrence of congestion is prevented in the bridge-hub apparatus 60b having the filtering function.

There have been proposed various techniques involving the bridging function and the routing function.

Japanese Patent Laid-Open (Kokai) No. HEI 7-143178 (hereinafter referred as publication 1) discloses a technique in which when a repeating system or a repeating apparatus receives data having a specific calling terminal address not corresponding to an address of a terminal from another connected terminal, the repeating system or the repeating apparatus performs a process to switch its operation mode.

By providing a plurality of addresses beforehand specified between the terminal apparatus and the repeating system or the repeating apparatus, it becomes possible to transmit data having a specific calling terminal address from the terminal apparatus to transit the operation mode of the repeating system or the repeating apparatus.

Japanese Patent Laid-Open (Kokai) No. HEI 7-221783 (hereinafter referred as publication 2) discloses a technique where a routing process and a bridging process can be switched from one to the other according to a logical network number and a physical network number arbitrarily designated to each node when data is transmitted between nodes on different LANs.

The routing apparatus has not only a means for the routing process but also a means for bridging process, it is thereby possible to switch between the routing process and the bridging process according to a logical network number and a physical network number designated to each node when data is transmitted between LANs.

However, the bridge-hub apparatus 60b does not have its own MAC address and IP address. For this, the bridge-hub apparatus 60b cannot capture control data into it. Namely, when the user sets bridging to the USD apparatus, the user cannot set a MAC address and an IP address to the DSU (Digital Service Unit) apparatus.

Accordingly, when the user monitors or controls a state of the bridge-hub apparatus 60b, the user cannot monitor or control the bridge-hub apparatus 60b using the terminal 10a in the same network 20 or a different network 21 such as Ethernet.

There is a one-unit apparatus in which the bridge-hub apparatus 60b and the routing apparatus are integrated. When the user switches between the bridging function and the routing function in such the one-unit apparatus, the user cannot control the apparatus since the apparatus having the bridging function does not have a MAC address and an IP address.

When the user switches from the bridging setting to the routing setting with respect to the setting of the DSU, an external interface (RS-232C) such as a change-over switch, an external terminal or the like is necessary in order to monitor or control the inside of the bridge-hub apparatus 60b. Without this, it is impossible to switch the setting. Namely, the user needs to prepare an external interface, which is cumbersome and inconvenient.

When the setting is switched to the routing function by a change-over switch, the user can insert control data into IP datagram, and transmits it. Whereby, the bridge-hub apparatus 60b as a modem is controlled, so that the user can monitor and control the DSU. Incidentally, this control is called IP control.

When IP datagram is processed at Layer 3 with a MAC address and an IP address, the switching speed decreases as compared with the bridge-hub apparatus 60b and the hub apparatus.

The technique disclosed in the publication 1 works well when the number of instructions for the operation of the repeating system is small. When the number of instructions for the operation increases, it is necessary to use a number of terminal addresses inside the network. Therefore, the number of terminals in the network is limited.

In the publication 2, the routing function is mainly considered. Both of a MAC address and an IP address are confirmed, and a destination of routing is determined with a reference table. Since examination is done even in IP layer, the routing process in the same network takes longer time than the bridge-hub apparatus.

### SUMMARY OF THE INVENTION

In the light of the above problems, an object of the present invention is to provide a transferring apparatus and a transfer controlling method for use in an IP data transmission technique on ATM, by which the user can individually switch control information about a terminal in a bridge-hub apparatus from the terminal in the same or in a different network, thereby switching at high speed.

The present invention therefore provides a transferring apparatus comprising a transmitting/receiving unit for inputting/outputting a frame including first lower identification data by which a terminal connected to a network can be identified, a lower identification data holding unit for holding specific lower identification data of a specific terminal apparatus connected to the network, and a lower layer frame processing unit for transferring the frame to either its own apparatus's side or other terminals' side connected to the network on the basis of the first lower identification data and the specific lower identification data.

The transferring apparatus comprises a bridge-hub apparatus and a routing apparatus without a changeover switch or a terminal for control separately provided, thereby controlling or monitoring a switching from a terminal in the same network or in a different network, and bridging without decreasing the switching speed.

The lower identification data holding unit may hold own lower identification data representing the apparatus itself as the specific lower identification data, and the lower layer frame processing unit may transfer the frame to the own apparatus's side when the first lower identification data agrees with the own lower identification data, while transferring the frame to the other terminals' side when the lower identification data does not agree with the own lower identification data.

Whereby, the frame processing at the upper layer is omitted so that the routing process in the same network is sped up.

The transmitting/receiving unit may comprise a plurality of ports to each of which an identification sign for identifying a service on a upper layer's side is assigned. Whereby, the upper layer can control input and output of data at the ports, so that the data transmission efficiency is improved.

The lower layer frame processing unit may comprise a lower identification data recognizing unit for recognizing that the received frame is the own lower identification data on the basis of the first lower identification data and the own lower identification data, a frame transferring unit for transferring a converted frame generated from the received frame to a upper layer's side when the lower identification data recognizing unit recognizes that the own lower identification data is the own lower identification data. Data of an apparatus or a terminal of other than the apparatus itself is switched with its own physical address at a lower layer, so that the processing at the upper layer is omitted, which leads to speed-up of the routing process in the same network.

The lower layer frame processing unit may comprise a lower identification data recognizing unit for recognizing that the received frame is broadcast lower identification data for broadcasting on the basis of the first lower identification data and the broadcast lower identification data for broadcasting, and a frame transferring unit for transferring a converted frame generated from the received frame to a upper layer's side and other ports different from a received port to which the received frame has been inputted among the plural ports. The transferring apparatus can thereby keep the transmission rate without decreasing the switching speed.

The lower identification data holding unit may relate an identification sign assigned to each of the plural ports with another lower identification data representing another terminal, and hold the identification sign and the another lower identification data. The transferring apparatus can thereby filter at high speed.

At least either the lower identification data recognizing unit or the frame transmitting unit of the lower layer frame processing unit may process for each of the plural ports. It is thereby possible to obtain a physical address of a terminal. The transferring apparatus can control data input/output at each port, so that the transferring becomes certain.

The transferring apparatus may further comprise a upper layer frame processing unit for generating first upper identification data on the basis of the converted frame transferred by the lower layer frame processing unit, and being able to output an agreement signal representing agreement or disagreement between the first upper identification data and own upper identification data representing the apparatus itself. Accordingly, the lower layer switches data of an apparatus or a terminal other than the apparatus itself with own physical address, so that the routing process can be sped up.

The transferring apparatus may use a upper identification data holding unit which is connected to the upper layer frame processing unit to hold the own upper identification data to output the agreement signal. The transferring apparatus can thereby distribute frames at a lower layer, and route them.

The lower layer frame processing unit may comprise a mask processing unit for limiting input and output of a frame at the transmitting/receiving unit on the basis of the agreement signal outputted from the upper identification data holding unit. The transferring apparatus can thereby manage output data, thus certain transferring becomes possible.

The present invention also provides a transfer controlling method comprising the steps of a request frame receiving step of receiving a predetermined request frame including at least either upper identification data of a specific terminal apparatus or broadcast lower identification data for broadcasting transmitted from a terminal connected to a network in order to obtain specific lower identification data of the specific terminal apparatus which can transfer a frame by a lower layer frame processing unit which transfers the predetermined request frame to either the apparatus's side or the other terminals' side connected to the network, and a selectively transferring step of selectively transferring a converted frame generated from the request frame received at the request frame receiving step from the terminal apparatus to at least either a upper layer or the other terminals.

The transferring apparatus does not need to separately have a change-over switch or a terminal for control, and the user can directly control the switching from a terminal in the network.

The selectively transferring step may comprise a upper layer transferring step of generating first upper identification data on the basis of the converted frame transferred by the lower layer frame processing unit when the transferring apparatus recognizes the own lower identification data, and transferring the converted frame to a upper layer frame processing unit which can output an agreement signal representing agreement or disagreement between the first upper identification data and own upper identification data representing the apparatus itself, a determining step of determining by the upper layer frame processing unit whether upper identification data of the converted frame transferred at the upper layer transferring step is the own upper identification data or not, and a responding step of transferring a response frame including own lower identification data corresponding to the own upper identification data to the other terminals from the upper layer frame processing unit when upper identification data of the converted frame is determined as the own upper identification data at the determining step. The transferring apparatus can thereby keep the transmission rate without decreasing the switching speed.

The transfer controlling method may further comprise the step of a upper layer transferring step of transferring the response frame to the upper layer from the upper layer frame processing unit when the upper identification data of the converted frame is determined as the own upper identification data at the determining step. The transferring apparatus is assigned both a physical address and a network address. The terminal can thereby set a path to the transferring apparatus using an existing method.

The selectively transferring step may comprise a upper layer-port transferring step of transferring said converted frame to the upper layer and other ports different from a receiving port to which the request frame has been inputted among the plural ports when the transferring apparatus recognizes broadcast lower identification data for broadcasting. The transferring apparatus can thereby certainly recognize the broadcast address.

The selectively transferring step may comprise a third transferring step of transferring the converted frame to the plural ports when the transferring apparatus recognizes identification data other than own lower identification data and the broadcast lower identification data. The transferring apparatus can thereby speed up the process.

The selectively transferring step may comprise a upper layer transferring step of transferring the converted frame to the upper layer when the transferring apparatus recognizes own lower identification data. The bridge-hub apparatus can thereby certainly recognize own physical address of the apparatus.

The selectively transferring step may comprise a protocol responding step of transmitting a response frame including lower identification data of the other terminal from the transferring apparatus to the other terminal. Accordingly, a terminal in the same network or a different network can IP-control an apparatus setting or apparatus information on the inside of the transferring apparatus.

The present invention still further provides a transfer controlling method comprising the steps of a frame receiving step of receiving a predetermined request frame including upper identification data of a transferring apparatus and broadcast lower identification data for broadcasting transmitted from a terminal connected to a network in order to obtain own lower identification data representing a terminal apparatus which can transfer a frame by a lower layer frame processing unit which transfers the predetermined request frame to either own apparatus's side or other terminals' side connected to the network, a first frame transferring step of transferring the request frame received at the frame receiving step to at least either ports assigned identification signs for identifying services on the upper layer's side or a upper layer from the lower layer frame processing unit, a determining step of determining whether upper identification data of the request frame is addressed to the transferring apparatus by the upper layer using a upper layer identification data holding unit which can hold data, and a second frame transferring step of transferring a notification frame generated from the request frame to a upper layer when the upper layer frame processing unit determines the transferring apparatus at the determining step.

Accordingly, a terminal in the same network or in a different network can set the transferring apparatus. Each user does not need to individually switch the transferring apparatus, or set a control on the terminal.

The transfer controlling method may further comprise an agreement signal transmitting step of transmitting an agreement signal representing agreement or disagreement between the first upper identification data and another upper identification data representing another terminal connected to the network to the lower layer frame processing unit from the upper layer on the basis of the request frame transmitted at the frame receiving step, and an output limiting step of limiting output of a frame from the port by the lower layer frame processing unit on the basis of the agreement signal transmitted at the agreement signal transmitting step. The transferring apparatus can control bridging. By masking transmission of an unnecessary frame, whereby the traffic can be decreased.

The present invention still further provides a transfer controlling method for use in an apparatus to which a frame including lower identification data by which a terminal connected to a network can be identified is inputted through each of a plurality of ports assigned identification signs for identifying services on a upper layer's side, the apparatus having a first function of outputting a frame including own lower identification data representing a terminal apparatus which can transfer a frame to a port corresponding to own lower identification data among the plural ports, and a second function of outputting a received frame from a receiving port to all the other ports among the plural ports, the transfer controlling method comprising the steps of a holding step of holding lower identification data of the terminals connected to the respective plural ports, and an output limiting step of limiting output of a frame through a masked port among the plural ports by a terminal connected to the receiving port to which the received frame has been inputted among the plural ports under a control of a upper layer.

Accordingly, the transferring apparatus fulfils the bridging function and the routing function. It is therefore possible to continue the operation of the system without largely changing the existing installation or system specifications even if the network relating equipment is varied in the future, so that wasteful investigation can be avoided.

### BRIEF DESCRIPTION OF THE DRAWINGS

FIG. 1 is a diagram showing a structure of a data transferring system according to a first embodiment of this invention;

FIG. 2 is a diagram for illustrating a schematic layer structure of a bridge-hub apparatus according to the first embodiment of this invention;

FIG. 3 is a diagram for illustrating a learning table according to the first embodiment of this invention;

FIG. 4 is a diagram for illustrating an operation at the time of ARP processing according to the first embodiment of this invention;

FIG. 5 is a diagram for illustrating an operation at the time of ARP processing according to the first embodiment of this invention;

FIG. 6 is a diagram for illustrating a schematic layer structure of a bridge-hub apparatus according to a second embodiment of this invention;

FIG. 7 is a diagram for illustrating an operation at the time of ARP processing of the bridge-hub apparatus according to the second embodiment of this invention;

FIG. 8 is a diagram for illustrating an operation at the time of a control on the bridge-hub apparatus according to the second embodiment of this invention;

FIG. 9 is a diagram for illustrating an operation at the time of ARP processing of a bridge-hub apparatus according to a third embodiment of this invention;

FIG. 10 is a diagram for illustrating an operation at the time of a control on the bridge-hub apparatus according to the third embodiment of this invention;

FIG. 11 is a diagram for illustrating a schematic layer structure of a bridge-hub apparatus according to a first modification of the third embodiment of this invention;

FIG. 12 is a diagram for illustrating an operation of a transfer controlling function of the bridge-hub apparatus according to the first modification of the third embodiment of this invention;

FIG. 13 is a diagram for illustrating an operation of a bridge-hub apparatus according to a second modification of the third embodiment of this invention;

FIG. 14 is a diagram for illustrating a learning table according to the second modification of the third embodiment of this invention;

FIG. 15 is a diagram showing a structure of an ATM cell transmission system;

FIG. 16 is a diagram for illustrating a schematic layer structure of a bridge-hub apparatus;

FIG. 17 is a diagram for illustrating a learning table;

FIG. 18(a) is a diagram showing an example of a format of IP addresses; and

FIG. 18(b) is a diagram showing an example of a format of MAC addresses.

### DESCRIPTION OF THE PREFERRED EMBODIMENTS

Hereinafter, description will be made of embodiments of this invention.

### (A) DESCRIPTION OF FIRST EMBODIMENT

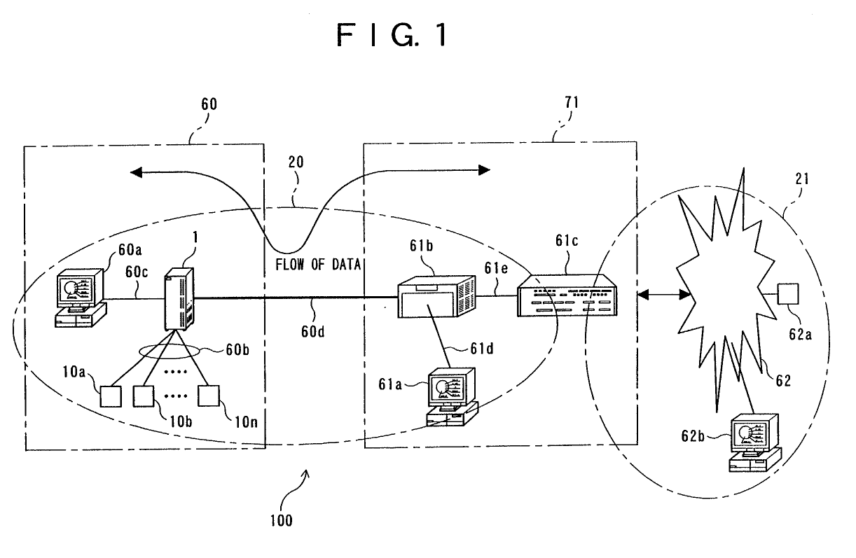

FIG. 1 is a diagram showing a structure of a data transferring system according to a first embodiment of this invention. A system 100 shown in FIG. 1 is a network system which transmits/receives or transfers high-speed, large volume data under a contract between a user and a carrier. The system 100 comprises a user's premise 60, a telephone central office 71 and the Internet 62. In cooperation of the user's premise 60 with the telephone central office 71, the same subnetwork 20 is configured. With the telephone central office 71 and the Internet 62, a different subnetwork 21 is configured.

The user's premise 60 is a house or an office of a subscriber or a general individual of the system 100, or a person who uses it for business or an operator who uses it for business. In the user's premise 60, a bridge-hub apparatus (transferring apparatus) 1 is disposed, which is connected to a bridge controllable terminal 60a, terminals 10a, 10b, . . . and 10n (n is a natural number not less than one), lines 60b and 60d and a cable 60c.

The bridge-hub apparatus 1 converts data received over the line 60b into an ATM cell, and transmits it to the telephone central office 71. Besides, the bridge-hub apparatus 1 receives an ATM cell from the telephone central office 71, extracts IP datagram or a frame from the received ATM cell, and transmits it to the terminal 10a, 10b, . . . or 10n. Details of the bridge-hub apparatus 1 will be described later.

The telephone central office 71 is an office belonging to a carrier who administrates the system 100, for example. The central office 71 provides a data transmission service along with services such as a telephone service, a facsimile service and the like. The central office 71 comprises a upper opposite apparatus 61b, a bridge controllable terminal 61a, an access routing apparatus 61c and cables 61d and 61e.

The upper opposite apparatus 61b disassembles an ATM-multiplexed ATM cell, extracts IP datagram or a frame, and transmits the IP datagram to the Internet 62 in the upstream. In the downstream, the upper opposite apparatus 61b encapsulates IP datagram from the Internet 62 into an ATM cell to ATM-multiplex it, and transmits it to the user's premise 60. Namely, the upper opposite apparatus 61b converts mainly Layer 2 data into Layer 3 data and vice versa, thereby terminating both Layer 2 and Layer 3.

The bridge controllable terminal 61a is a terminal which can control the upper opposite apparatus 61b. This function is accomplished by, for example, a personal computer. The cables 61d and 61e are LAN cables, for example. Over these cables 60c and 61e, data is transmitted/received among the terminal and the apparatuses.

The routing apparatus 61c routes IP datagram. An ATM cell received over the line 60d is disassembled into IP datagram in the upper opposite apparatus 61b, and the routing apparatus 61c selects the most suitable route for the IP datagram to transfer it.

The same subnetwork 20 is conFIGured between the user's premise 60 and the telephone central office 71, so that the user can transmit/receive data such as a large amount of Web information, images and the like.

The Internet 62 is a network using mainly IP protocol. A bridge controllable terminal 62a, an information server 62b, a number of workstations and personal computers are connected to the Internet 62. The bridge controllable terminal 62a is a terminal that can control a upper opposite apparatus (not shown) connected to the Internet 62. This function is accomplished by, for example, a personal computer. The information server 62b provides Web information and the like.

The user can access to the Internet 62 through the bridge-hub apparatus 1, and the telephone central office 71 using the terminal 10a, 10b, . . . , or 10n to see information in the information server 62b, or down-load a file, for example.

The different subnetwork 21 is configured between the central office 71 and the Internet 62, so that the central office 71 can transmit/receive, for example, image data as telephone signals.

In the following description, the same subnetwork 20 and the different subnetwork 21 will be simply referred as the networks 20 and 21, respectively, occasionally.

The bridge-hub apparatus 1 also functions as a DSU, for example, of an asymmetric digital subscriber line. Namely, the bridge-hub apparatus 1 transmits/receives data in a high frequency band to/from both the user and the line 60d. Incidentally, “asymmetric” signifies that the upstream transmission rate differs from the downstream transmission rate.

Accordingly, the user can use the xDSL connection service provided by an Internet service provider, for example. The user can also use the existing installation so as to transmit/receive data at high speed over a subscriber telephone line without an optical fiber.

The bridge-hub apparatus 1 has a function of repeating a frame and IP datagram to the networks 20 and 21 along with the function as the DSU apparatus. When focusing on the repeating apparatus, the bridge-hub apparatus 1 is also an apparatus for bridging-hub or routing.

By means of bridging, a received frame is transmitted to another route at Layer 2 without being processed at Layer 3. The bridging function includes two functions, that is, a function of only repeating a frame and a filtering function, as well known.

The filtering function signifies a function of mainly transferring a received frame to another route at Layer 2, not processing at Layer 3. The filtering function is accomplished by that the frame always inserts a destination MAC address to itself. For instance, the bridge-hub apparatus 1 identifies a MAC address included in a frame transmitted from the terminal 10a, 10b, . . . , or 10n, and allows only a frame having own MAC address of the bridge-hub apparatus 1 itself to pass through to another route.

The MAC address functions as lower identification data for identifying a terminal in the network 20 at MAC layer. The IP address functions as upper identification data for identifying a terminal in the network 20 at IP layer.

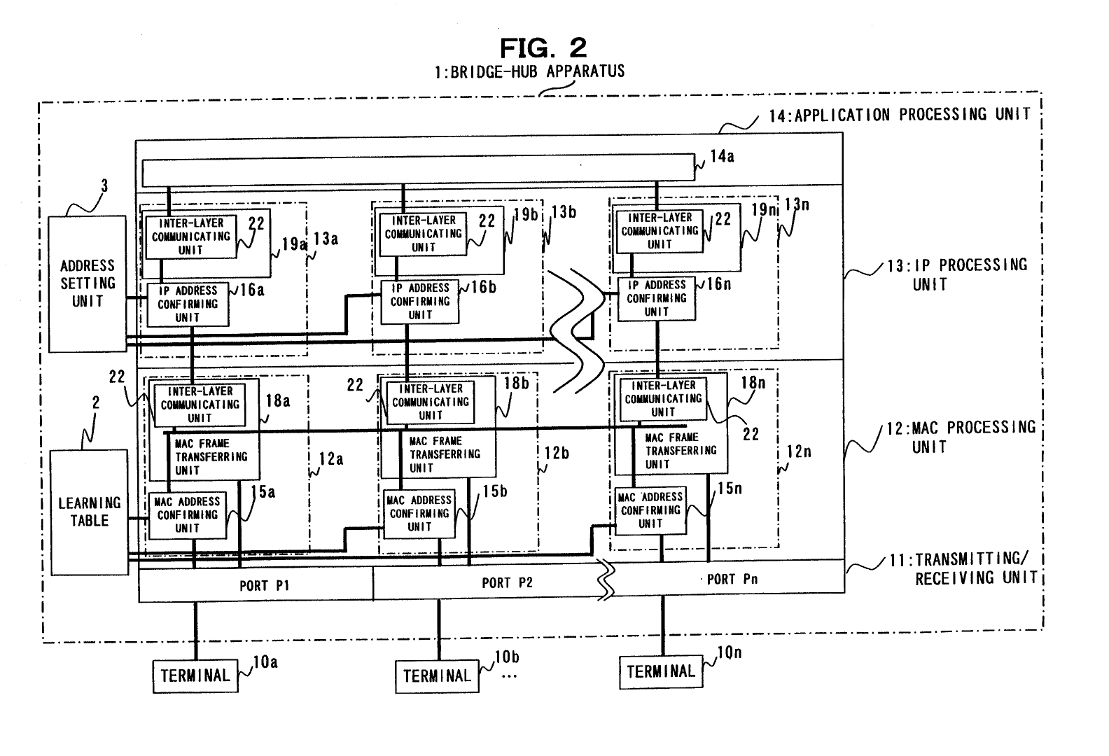

Incidentally, “terminal” also signifies not only the terminals 10a-10n shown in FIG. 2 but also a terminal in the network 20. “Terminal in the network 20” signifies a terminal or an apparatus included in the network 20, which is, for example, a personal computer, a portable information equipment, a bridge apparatus, a hub apparatus, a bridge-hub apparatus, a routing apparatus, or the like.

“Own MAC address” signifies a MAC address of the bridge-hub apparatus 1, or a bridge-hub apparatus 1a, 1b or 1c to be described later in a second embodiment, a third embodiment, or each modification (hereinafter referred as another modification, occasionally). The bridge-hub apparatus 1 has neither its own MAC address nor its own IP address. Here, “own IP address” signifies an IP address of the bridge-hub apparatus 1, or a bridge-hub apparatus 1a, 1b, or 1c to be described later.

The function at Layer 2 includes a hub function along with the bridging function. In the following description, the bridging function will be mainly described. In the first embodiment, the bridge-hub apparatus 1 having the filtering function will be described. In a modification of the first embodiment to be described later, the bridge-hub apparatus without the filtering function will be described.

The bridge controllable terminal 60a is a terminal that can control the bridge-hub apparatus 1. This function is accomplished by, for example, a personal computer. The cable 60c is, for example, a LAN cable. By means of the cable 60c, data can be transmitted/received between the bridge controllable terminal 60a and the bridge-hub apparatus 1.

Each of the terminals 10a, 10b, . . . , and 10n is used by the user to transmit/receive data to/from the bridge-hub apparatus 1.

The line 60b is a subscriber telephone line. The line 60d is used to transmit/receive an ATM cell undergone the ATM layer process, which includes an ATM switching system, an ATM routing apparatus (ATM router) and the like although not shown. An ATM network is conFIGured with the line 60d.

In the upstream, IP datagram or a frame transmitted from the user is encapsulated into an ATM cell, and the ATM cell is ATM-multiplexed and transmitted to the telephone central office 71. In the downstream, ATM-multiplexed data transmitted from the telephone central office 71 is received by the bridge-hub apparatus 1, and ATM-terminated therein, then IP datagram or a frame is transferred to the terminal 10a, 10b, . . . , or 10n.

FIG. 2 is a diagram for illustrating a schematic layer structure of the bridge-hub apparatus 1 according to the first embodiment of this invention. The bridge-hub apparatus 1 shown in FIG. 2 has the filtering function, which comprises a transmitting/receiving unit 11, a MAC processing unit (lower layer frame processing unit) 12, an IP processing unit (upper layer frame processing unit) 13, an application processing unit 14, a learning table (lower identification data holding unit) 2, and an address setting holding unit (upper identification data holding unit; hereinafter abbreviated as an address setting unit, occasionally) 3.

The transmitting/receiving unit 11 inputs and outputs a frame including a transmission source MAC address by which each of the terminals 10a-10n connected to the network 20 can be identified. The transmitting/receiving unit 11 comprises n ports P1-Pn each assigned a port number (identification sign) for identifying a service on the upper layer's side. The upper layer's side service includes not only a service at Layer 4 but also services at Layer 5 to Layer 7, which signifies, for example, FTP (File Transfer Protocol), Telnet and the like. The port number is a well-known port number. For instance, FTP represents the twenty-first, and Telnet represents the twenty-third.

Each of the ports P1-Pn is inputted a MAC frame from a corresponding terminal 10a, 10b, . . . , or 10n, and outputs the MAC frame to the terminal 10a, 10b, . . . , or 10n. Each of the ports P1-Pn performs an operation corresponding to the Layer 1 process.

A upper layer such as an application layer or the like can control input and output of data at the ports P1-Pn, which improves the data transmission efficiency.

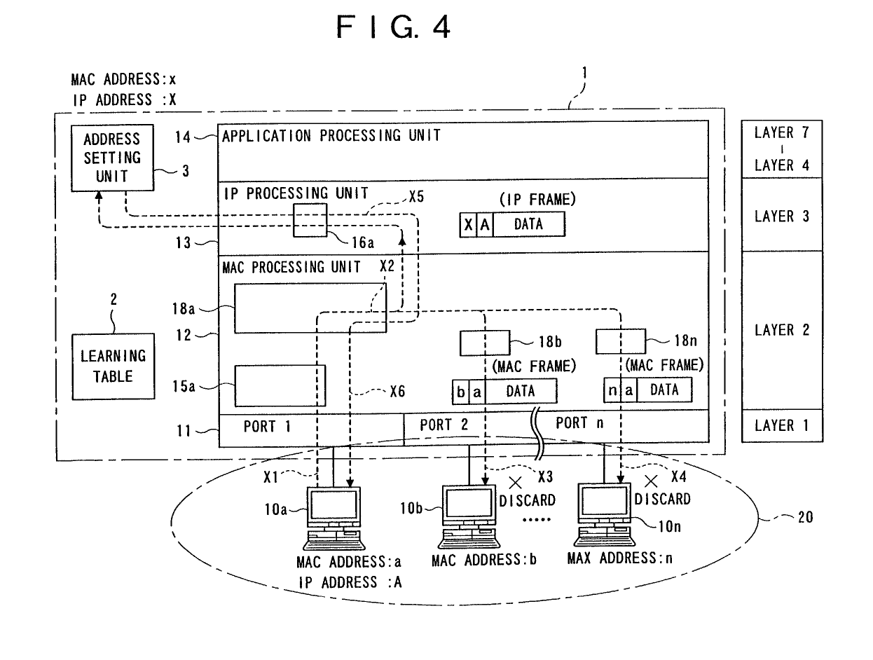

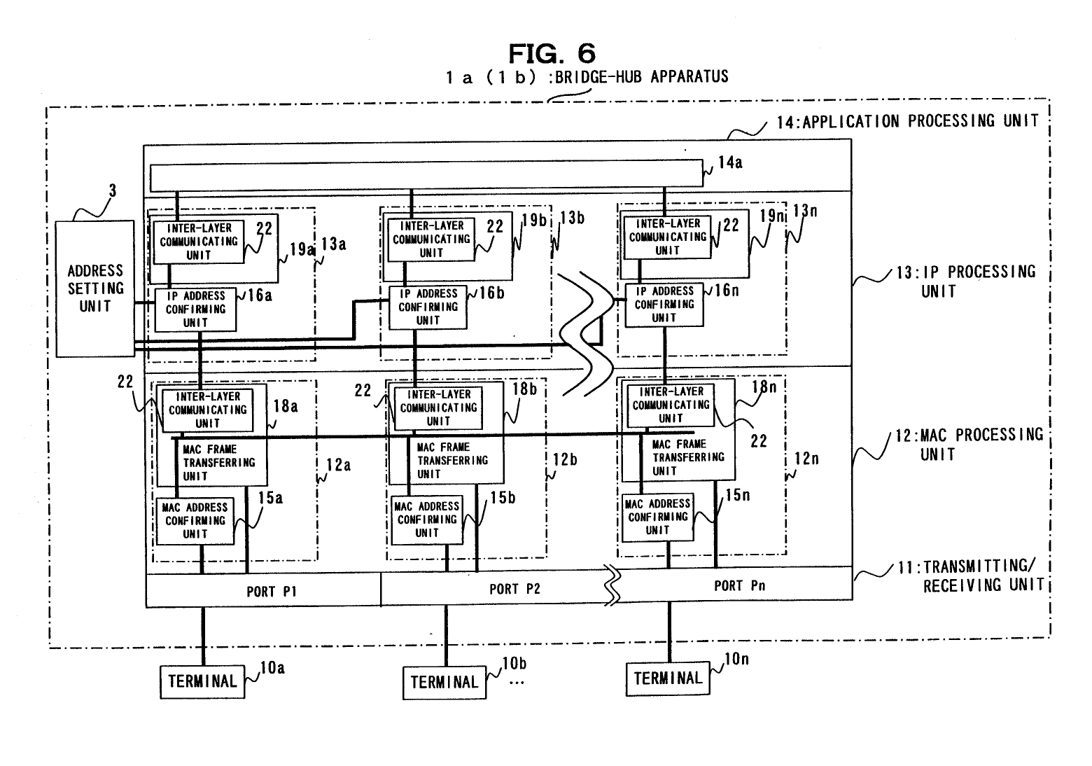

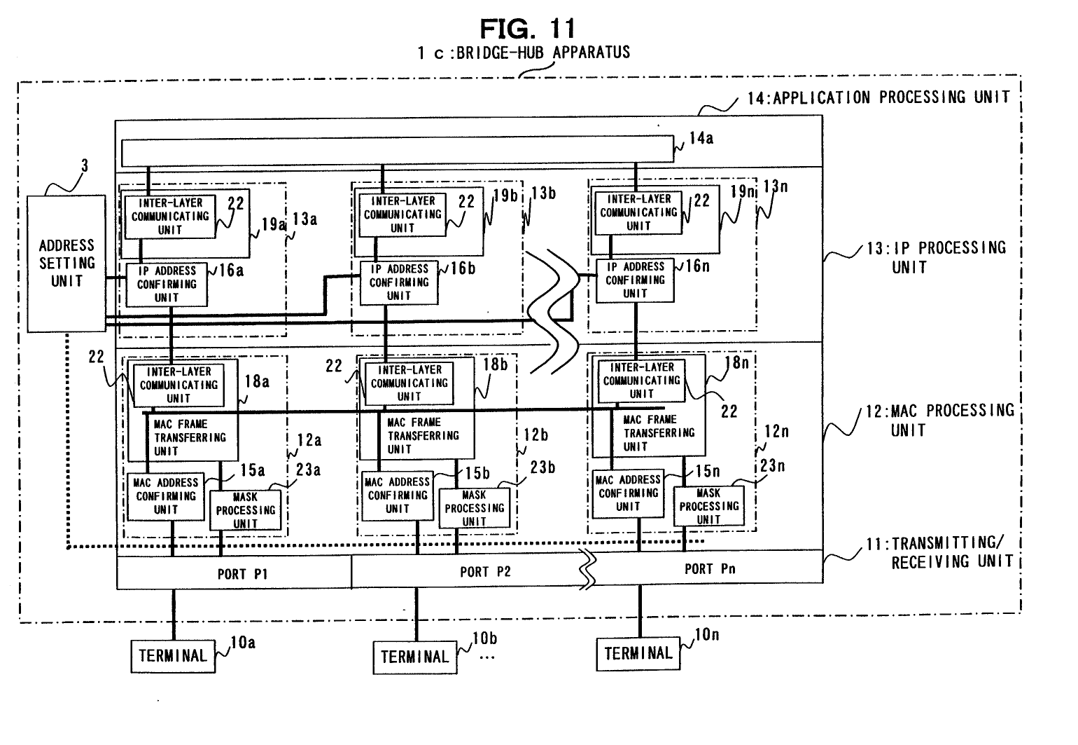

In the following description, the port P1 will work mainly as a port for frame transmission/reception (for data input/output). Incidentally, one port or plural ports not less than two among the other ports P2-Pn excepting the port P1 may be assigned for frame transmission/reception. In FIG. 2, and FIGS. 6 and 11 to be described later, thick lines represent transmission of data (signals). Additionally, the ports P1, P2, . . . , and Pn will be denoted as ports 1, 2, . . . , and n in FIGS. 4, 5, 7 to 10, 12 and 13 to be described later.

The MAC processing unit 12 transfers a frame to its own apparatus's side and to the terminals' side 10b-10n connected to the network 20 on the basis of a transmission source MAC address and the own MAC address. The MAC processing unit 12 comprises n sub MAC processing units 12a-12n corresponding to the respective ports P1-Pn.

Namely, the MAC processing unit 12 terminates a protocol for a MAC frame, extracts a MAC address from the MAC frame, and transmits data included in the received MAC frame to the upper layer and all the ports P2-Pn excepting the port P1. The MAC processing unit 12 receives data transmitted from the upper layer and data transmitted from each of the ports P1-Pn, and transmits frames from the port P1.

The MAC processing unit 12 detects collision. These operations are performed for each frame, and an operation corresponding to the Layer 2 process is again performed.

Incidentally, transfer to its own apparatus's side includes a case where a frame is directly transferred to a upper layer of the apparatus (bridge-hub apparatus 1), and a case where a frame is once outputted to the outside of the bridge-hub apparatus 1. Namely, the MAC processing unit 12 selectively transmits a converted frame undergone the converting process by changing the header of a received frame or replacing the header to the bridge-hub apparatus 1 or the other terminals 10a-10n.

The sub MAC processing unit 12a transfers a received frame from the port P1 to the IP processing unit 13 or another sub MAC processing unit 12b, 12c, . . . , or 12n, besides outputting a frame transferred from the IP processing unit 13 or another sub MAC processing unit 12b, 12c, . . . , or 12n from the port P1. The sub MAC processing unit 12a comprises a MAC address confirming unit (lower identification data recognizing unit) 15a, and a MAC frame transferring unit (MAC frame transmitting unit) 18a.

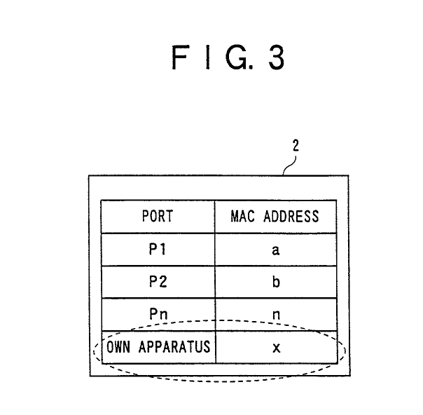

The MAC address confirming unit 15a recognizes, on the basis of a MAC address of a frame received by the transmitting/receiving unit 11 and another MAC address held in the learning table 2 to be described later with reference to FIG. 3, that the received frame has its own MAC address. In other words, the MAC address confirming unit 15a confirms an address by this recognition.

The MAC address confirming unit 15a can rewrite contents held in the learning table 2. This function is accomplished by a CPU (Central Processing Unit), a ROM (Read Only Memory) and a RAM (Random Access Memory).

Accordingly, it is possible to keep the transmission rate without decreasing the switching speed even when the bridge-hub apparatus 1 has the filtering function.

The MAC address confirming unit 15a recognizes, on the basis of a transmission source MAC address and its own MAC address, that the received frame has its own MAC address. The MAC address confirming unit 15a also recognizes, on the basis of a transmission source MAC address and a broadcast MAC address for broadcasting, that the received frame has a broadcast MAC address.

In more detail, when the MAC address confirming unit 15a recognizes that the received frame has its own MAC address, the MAC frame transferring unit 18a transfers a converted frame obtained by converting the received frame to the upper layer's side. This function is accomplished by a CPU, a ROM, a RAM and a data bus (not shown).

Namely, the MAC frame transferring unit 18a transfers a MAC frame to all the ports P2-Pn excepting the port P1 having received the frame by receiving an address agreement signal or an address disagreement signal from the address setting unit 3 about the MAC frame received by the port P1. The MAC frame transferring unit 18a transfers it frame by frame.

The MAC frame transferring unit 18a comprises an inter-layer communicating unit 22 which can transmit/receive a frame between the MAC layer and the IP layer. A function of the inter-layer communicating unit 22 is accomplished by, for example, a socket communication.

An example of the socket communication method is that an application program realizing the layer function converts a protocol stack of a received frame, writes the converted frame and a layer of a transmission destination into a mail or a message, calls the OS (Operating System), and the called OS reads the mail or message, and requests the layer of the transmission destination to process the mail or the message data.

When the MAC address confirming unit 15a recognizes that the received frame has a MAC address for broadcasting, the MAC frame transferring unit 18a transfers a converted frame obtained by converting the received frame to the upper layer's side and all the ports excepting a port to which the received frame has inputted among the n ports P1-Pn.

At Layer 2, data of other than the apparatus is switched with its own MAC address, whereby the process at Layer 3 is omitted. This allows speed-up of the routing process in the same network 20.

Each of the sub MAC processing units 12b-12n is similar to the sub MAC processing unit 12a, which comprises the MAC address confirming unit (lower identification data recognizing unit) 15b, 15c, . . . , or 15n and the MAC frame transferring unit 18b, 18c, . . . , or 18n. Each of the MAC address confirming units 15b-15n is similar to the MAC address confirming unit 15a, while each of the MAC frame transferring unit 18b-18n is similar to the MAC frame transferring unit 18a, duplicated descriptions of which are thus omitted.

The MAC address confirming units 15a-15n and the frame transferring unit 18a-18n of the MAC processing unit 12 cooperate to process data at the n ports P1-Pn, respectively.

The learning table 2 holds specific MAC addresses (own lower identification data) of specific terminal apparatuses connected to the network 20.

“Specific terminal apparatus” signifies a terminal connected to the network or an apparatus connected to the network, which includes a bridge apparatus, a hub apparatus, a bridge-hub apparatus, a routing apparatus and the like along with a personal computer terminal. In concrete, -the specific terminal apparatus signifies the bridge-hub apparatus 1 (bridge-hub apparatus 1a, 1b or 1c in the other embodiment to be described later).

The learning table 2 relates a MAC address assigned to each of the n ports P1-Pn with another MAC address representing another terminal, and holds them. This function is accomplished by, for example, a hard disk, a RAM or the like. The data is held as shown in FIG. 3, for example.

FIG. 3 is a diagram for illustrating the learning table 2 according to the first embodiment of this invention. The learning table 2 shown in FIG. 3 holds MAC addresses transmitted from the terminals 10a-10n connected to the respective ports P1-Pn, along with own MAC address of its apparatus (own apparatus) as encircled by a broken line. Namely, the learning table 2 learns the MAC addresses of the terminals 10a-10n connected to the respective ports P1-Pn. A received frame is transferred to a port P1, P2, . . . , or Pn according to data in the learning table 2. Accordingly, the bridge-hub apparatus 1 can filter at high speed.

When the learning table 2 is in the initial state, a frame is transmitted to each of the ports P1-Pn. When the bridge-hub apparatus 1 is initialized, any one of the MAC address confirming units 15a-15n writes a MAC address of the bridge-hub apparatus 1.

In the learning table 2, contents thereof (port number, MAC address and the like) are rewritten according to an instruction transmitted from the IP processing unit 13 using IP control. For instance, a MAC address “a” is set to the port P1.

When the bridge-hub apparatus 1 receives a frame having its own MAC address, the frame is not transferred to the IP processing unit 13, but transferred to the other ports P2-Pn, so that the filtering function is exhibited.

When the terminal 10a, for example, transmits a frame to the bridge-hub apparatus 1, the port P1 receives the frame. The MAC address confirming unit 15a extracts a MAC address of the frame, and compares the MAC address with each MAC address held in the learning table 2. When the extracted MAC address is addressed to the bridge-hub apparatus 1, the frame is transferred to the IP processing unit 13 via the frame transferring unit 18a, and the inter-layer communicating unit 22. When each of the terminals 10b-10n transmits a frame, the data is processed in the similar manner to the case of the terminal 10a.

A frame from the IP processing unit 13 to the terminal 10a is received by the sub MAC processing unit 12a, and outputted to the terminal 10a from the port P1 via the inter-layer communicating unit 22 and the sub MAC address confirming unit 15a. When a frame is transmitted from any one of the sub MAC processing units 12a-12n to the terminal 10b, 10c, . . . , or 10n, the data is processed in the similar manner to the case of the sub MAC processing unit 12a.

In the bridge-hub apparatus (transferring apparatus) 1 according to this invention, the learning table 2 holds own MAC address representing its own apparatus as own MAC address, and the MAC processing unit 12 transfers a frame to its own apparatus's side when the transmission source MAC address agrees with the own MAC address, while transferring the frame to the side of the terminals 10b-10n when the MAC address does not agree with the own MAC address.

Accordingly, one kind of bridge-hub apparatus 1 can simultaneously carry out the hub function and the routing function.

The address setting unit 3 shown in FIG. 2 is connected to the IP processing unit 13 to hold the own IP address. This function is accomplished by, for example, a RAM or the like. In the address setting unit 3, an IP address of the bridge-hub apparatus 1 is set by, for example, the IP address confirming unit 16a, and contents thereof are held. In order to set the IP address, the IP address is rewritten according to an instruction under the IP control of the external terminal 10a, for example.

When an IP frame generated from the received frame agrees with the held IP address, the IP frame is transferred to the application processing unit 14.

Namely, an IP frame is assembled from a frame transferred from the MAC processing unit 12, and an IP address is created and compared with each IP address held in the learning table 2. Accordingly, the bridge-hub apparatus 1 can distribute a frame at MAC layer, and routes the distributed frame.

When a MAC frame is received from the terminal 10a, 10b, . . . , or 10n connected to the port P1, P2, . . . , or Pn, the terminal 10a, 10b, . . . , or 10n makes the bridge-hub apparatus 1 learn the MAC address on the basis of the MAC frame. The bridge-hub apparatus 1 transmits the received MAC frame to all the ports P2-Pn excepting (differing from) the port P1 for transmission/reception.

The bridge-hub apparatus 1 can be given a MAC address and IP address even without the filtering function, so as to be identified in the network 20.

By giving these addresses, the user can directly IP-control a setting or information relating to the bridge-hub apparatus 1 from the terminal 10a, 10b, . . . , or 10n in the same network 20 or the different network 21. In consequence, each user does not need to individually switch the bridge-hub apparatus 1 or set the control on the terminals 10a-10n.

As a result, switching of the bridge-hub apparatus 1 can be processed at Layer 2, which leads to speeding-up of the process.

The IP processing unit 13 generates a first IP address on the basis of a converted frame transferred by the MAC processing unit 12, besides being able to output an agreement signal representing agreement or disagreement between the first IP address and own IP address representing its own apparatus. The IP processing unit 13 comprises n sub IP processing units 13a-13n.

In concrete, the IP processing unit 13 assembles an IP frame to generate IP datagram, and extracts an IP address from the IP datagram. This operation is performed for each frame, and an operation corresponding to the Layer 3 process is performed.

The sub IP processing unit 13a can generate a first IP address on the basis of a converted frame transferred by the sub MAC processing unit 12a, and output an agreement signal representing agreement or disagreement between the fist IP address and own IP address representing its own apparatus. Each of the sub IP processing units 13b-13n operates similarly to the sub IP processing unit 13a, further description of which is thus omitted. The sub IP processing unit 13a comprises an IP frame processing unit 19a and an IP address confirming unit 16a.

The IP frame processing unit 19a assembles frames received from the sub MAC processing unit 12a to generate IP datagram, besides disassembling IP datagram inputted from the application processing unit 14 to generate frames. Incidentally, like reference characters designate parts having the same or similar functions, further descriptions of which are thus omitted.

The IP address confirming unit 16a extracts an IP address of the IP datagram generated by the IP frame processing unit 19a, and recognizes that the received frame is of an address for control on its own apparatus, on another apparatus or on the other on the basis of the IP address and an IP address held in the address setting unit 3. The function of the sub IP processing unit 13a is accomplished by, for example, a CPU, a ROM, a RAM and the like.

The received frame is transferred to the upper application processing unit 14 via the MAC processing unit 12, or turned down to be transferred to the MAC processing unit 12, or discarded.

Accordingly, Layer 2 switches data of another apparatus using its own MAC address, so that the routing processing is sped up.

The application processing unit 14 processes data relating to a control on the bridge-hub apparatus 1. In concrete, the application processing unit 14 performs an operation corresponding to a process at not lower than Layer 4.

When text data (hereinafter referred as application data, occasionally), for example, generated for the terminal 10n using the upper application is transferred from the application processing unit 14 to the IP processing unit 13, a destination address of IP datagram having the transferred application data is recognized by the IP address confirming unit 16a, fragmented, then transferred to, for example, the sub MAC processing unit 12a. The fragmented frames are inputted from the sub MAC processing unit 12a to the sub MAC processing unit 12n. The MAC frame transferring unit 18n outputs the frames to the port Pn. The frames are then transmitted to the terminal 10n.

As above, a MAC address and an IP address are judged and recognized at both Layer 2 and Layer 3. When the user uses the bridge-hub apparatus 1, the user does not need to provide, for example, an external change-over switch in order to fixedly process Layer 2 or Layer 3. This largely improves the operability of the user, and simplifies the maintenance and management.

Since the bridge-hub apparatus 1 (hub apparatus) can obtain a MAC address of the terminal 10a via the port P1, data is not transmitted from the port P1 under the port filter control, thus the transfer becomes certain.

Next, detailed description will be made of an ARP (Address Resolution Protocol) controlling method in the system in the above structure according to the first embodiment of this invention.

ARP is a protocol that automatically converts an IP address of 32 bits and a MAC address of 48 bits from one to the other. With an IP address, a upper layer than the IP processing unit 13 manages a communication.

In more detail, ARP is used to acquire a MAC address of an object whose IP address is known. Namely, the terminal 10a that desires to know a MAC address of the bridge-hub apparatus 1 broadcasts an ARP request frame (referred as an ARP request message, an ARP request or a request frame) designating an IP address of the bridge-hub apparatus 1 to the same network 20. The bridge-hub apparatus 1 makes a pair of its own MAC address and IP address, and transmits a response message to the terminal 10a.

The terminal 10a can update the pair of MAC address and IP address. For update, the bridge-hub apparatus 1 beforehand sets its own IP address as an initial value (default value) in the address setting unit 3. This IP address can be rewritten using the IP control by each of the terminals 10a-10n connected to the respective ports P1-Pn.

With no IP address of each terminal P1, P2, . . . , or Pn or the apparatus being recorded in the learning table 2 (hereinafter referred as an initial state, occasionally), a MAC frame from the terminal 10a, 10b, . . . , 10n is transmitted to the ports P1-Pn.

When the setting relating to the bridge-hub apparatus 1 is initialized (hereinafter referred as initialization), own MAC address of the bridge-hub apparatus 1 is written in the sub MAC address confirming unit 12b. For this, the frame is not transferred to the IP processing unit 13 corresponding to Layer 3.

When a received frame has the own MAC address, or a broadcast address used to request to transmit an ARQ request frame, the frame is transferred to the IP processing unit 13.

The IP processing unit 13 determines whether an IP address of the frame is the own IP address or not. When the IP addresses agree with each other, the IP processing unit 13 transfers a converted frame to the application processing unit 14 having a function at not lower than Layer 4, at which the transferred converted frame is processed. When the IP address of the frame differs from the own IP address, the IP processing unit 13 discards the frame.

When the IP address of the frame is a local MAC address, the IP processing unit 13 alters the own MAC address recorded in the learning table 2 using the IP control. The altered own MAC address is read by the sub MAC address confirming unit 12b.

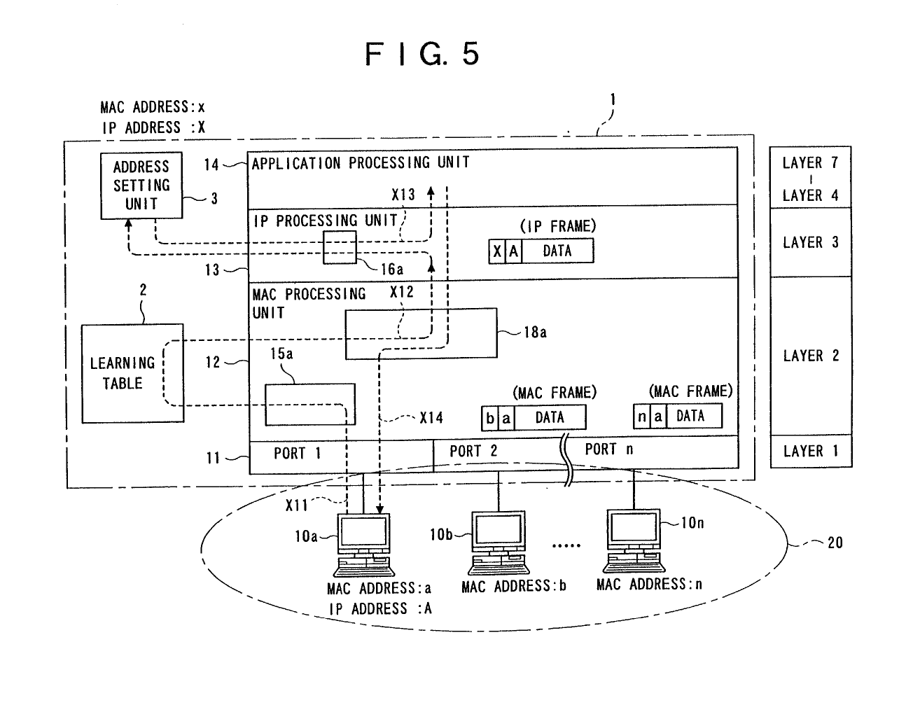

Next, the above will be described in more detail with reference to FIGS. 4 and 5. In FIGS. 4 and 5, like reference characters designate parts having the same or similar functions, further descriptions of which are thus omitted. First, a case where the terminal 10a controls the bridge-hub apparatus 1 will be described with reference to FIG. 4. Secondary, a control on the bridge-hub apparatus 1 will be described with reference to FIG. 5.

FIG. 4 is a diagram for illustrating an operation of the ARP processing according to the first embodiment of this invention. The bridge-hub apparatus 1 shown in FIG. 4 comprises the transmitting/receiving unit 11 and the like corresponding to Layers 1 to 4, respectively. The terminals 10a-10n are connected to the ports P1-Pn of the transmitting/receiving unit 11, respectively. FIG. 4 also shows layer levels 1 to 7 corresponding to respective Layers 1 to 7 for the sake of reference. A broken line drawn from the terminal 10a shows a flow of a frame, representing that a frame is transmitted from the terminal 10a. Now, frame processing denoted by messages X1-X6 will be described.

Here, a MAC address of the bridge-hub apparatus 1 is “x”, while an IP address of the same is “X”. A MAC address and an IP address of the terminal 10a are “a” and “A”, respectively. A MAC address of the terminal 10b is “b”, whereas a MAC address of the terminal 10n is “n”. These addresses will be the same in FIGS. 5, 7, 8, 9, 10, 12 and 13 to be described later. For the sake of simplicity, parts shown in FIG. 2 which are unnecessary for the description are omitted here.

In order that the user of the terminal 10a, for example, uses the bridge-hub apparatus 1, a MAC address of the terminal 10a is written in the learning table 2 of the bridge-hub apparatus 1. In order that the terminal 10a obtains a MAC address of the bridge-hub apparatus 1, the terminal 10a sets an IP address “X” of the bridge-hub apparatus 1 as the destination IP address included in an ARQ request frame, and the broadcast address as the destination MAC address.

Namely, the terminal 10a sets “broadcast address” as the destination MAC address and “X” as the destination IP address, then transmits the ARQ request frame to the port P1 (message X1).

When the ARQ request frame is received by the port P1, the MAC address confirming unit 15a determines whether the destination MAC address is the broadcast address or not. When it is determined that the destination MAC address is the broadcast address, the MAC frame transferring unit 18a does not refer to the learning table 2 (message X2), but transfers the ARQ request message received by the port P1 to the IP processing unit 13 and the other ports P2-Pn (messages X3 and X4). Incidentally, it is checked whether the destination IP address of the frame is the own IP address or not. When the destination IP address is not the own IP address, the frame is discarded.

The IP processing unit 13 determines whether the destination IP address of the frame is the own IP address or not by referring to the address setting unit 3. When the addresses agree with each other as a result, the IP processing unit 13 transmits an IP frame to the MAC processing unit 12 in order to transmit an ARP response frame (referred as an ARP response message, an ARP response or a response frame) to the terminal 10a.

The MAC processing unit 12 sets the own MAC address as the transmission source MAC address of the frame, and transmits an ARQ response frame to the terminal 10a (message X6). Whereby, the terminal 10a gets to know a MAC address of the bridge-hub apparatus 1 from the transmission source MAC address of the transmitted ARQ response frame. The terminal 10a sets a control signal (control data) for controlling the bridge-hub apparatus 1 for IP datagram.

The bridge-hub apparatus 1 can thereby recognize not only a frame but also IP datagram.

Meanwhile, each of the terminals 10b-10n operates similarly to the terminal 10a.

According to a transfer controlling method of this invention, an ARQ request frame including an IP address of the bridge-hub apparatus 1 transmitted from a terminal 10a, 10b, . . . , or 10n connected to the network 20 in order to obtain a MAC address of the bridge hub apparatus 1 that can transfer a frame is received by the MAC processing unit 12 that transfers a frame to the apparatus's side or to the other terminals' side connected to the network 20 (request frame receiving step).

The bridge-hub apparatus 1 selectively transfers a converted frame obtained by converting the ARQ request frame received at the request frame receiving step to a upper layer or to the other terminals (selectively transferring step).

In selectively transferring (at the selectively transferring step), when the bridge-hub apparatus 1 recognizes its own MAC address, the bridge-hub apparatus 1 generates a first IP address on the basis of the converted frame transferred by the MAC processing unit 12, and transfers the converted frame to the IP processing unit 13 that can output an agreement signal representing agreement or disagreement between the first IP address and own IP address representing its own apparatus (upper layer transferring step).

The IP processing unit 13 then determines whether the IP address of the converted frame transferred at the upper layer transferring step is the own IP address or not (determining step).

When it is determined at the determining step that the IP address of the converted frame is the own IP address, the IP processing unit 13 transfers an ARQ response frame including the own MAC address corresponding to the own IP address to the other terminal (responding step).

As above, the bridge-hub apparatus 1 does not need to separately have a change-over switch and a terminal for control, and the user can directly control the switching from the terminal in the same network 20 or in a different network 21.

Accordingly, the bridge-hub apparatus I having the filtering function can keep the transmission rate without decreasing the switching speed. Additionally, the bridge-hub apparatus 1 is given one MAC address and one IP address, whereby each of the terminals 10a-10n can set a path to the bridge-hub apparatus 1 in the existing manner.

Next, an operation of controlling the bridge-hub apparatus 1 will be described with reference to FIG. 5.

FIG. 5 is a diagram for illustrating an operation at the time of the ARP processing according to the first embodiment of this invention. In FIG. 5, like reference characters designate parts having the same or similar functions, further descriptions of which are thus omitted.

The terminal 10a transmits an ARQ request frame to the port P1 (message X11). In the bridge-hub apparatus 1, the above control data is switched. The destination IP address and the destination MAC address are retrieved by referring an IP address of the bridge-hub apparatus 1 and a MAC address recorded in the learning table 2. When the address agrees with the own MAC address, the ARQ request frame is transferred to the IP processing unit 13 (message X12).

The IP processing unit 13 determines whether the destination IP address of the frame is the own IP address or not. When the addresses agree with each other, the IP processing unit 13 transfers the frame to the application processing unit 14 (message X13). The application processing unit 13 processes the transferred frame. When the address of the frame disagrees with the own IP address, the IP processing unit 13 discards the frame.

The application processing unit 14 transmits an ARQ response frame to the terminal 10a (message X14).

According to the transfer controlling method of this invention, the IP processing unit 13 determines whether an IP address of a transferred converted frame is the own address or not (determining step). When it is determined at the determining step that the address is the own IP address, the IP processing unit 13 transfers an ARQ response frame to a upper layer (upper layer transferring step).

Accordingly, the bridge-hub apparatus 1 is assigned one MAC address and one IP address like a terminal in the same network 20. Whereby, each of the terminals 10a-10n can set a path to the bridge-hub apparatus 1 just like the terminal transmits a frame to another terminal in the same network 20.

As above, Layer 2 (MAC processing unit 12) switches data of an apparatus other than its own apparatus using own MAC address, so that the process at Layer 3 (by the IP processing unit 13) is omitted. Therefore, the routing process in the same network can be sped up.

As above, the user can directly IP-control an apparatus setting of or apparatus information on the inside of the bridge-hub apparatus 1 from a terminal 10a, 10b, . . . , or 10n in the same network or a different network 21.

In the system 100 (refer to FIG. 1), IP datagram or a frame in the upstream from the user is ATM-multiplexed, and transmitted to the Internet 62 via the telephone central office 71. In the downstream, an ATM cell from the Internet 62 is received by the bridge-hub apparatus 1, the ATM cell is ATM-terminated and transferred as IP datagram or a frame to the terminal 10a, 10b, . . . , or 10n. It is thereby possible to certainly transmit/receive high-speed, large-capacity data.

Since the upper layer (application processing unit 14) inputs an instruction for operation to the bridge-hub apparatus 1 just like the upper layer transmits/receives to/from the terminal 10a, 10b, . . . , or 10n in the same network 20, it can be avoided that the number of terminals 10a-10n in the network is limited even when the number of instructions for operation is increased.

As above, the bridge-hub apparatus 1 exhibits the bridge function and the routing function, so that the carrier can continue the operation of the system without largely changing the existing installation or system specifications even when relating equipment of the network is varied in the future. Thus, wasteful investigation can be avoided.

### (B) DESCRIPTION OF SECOND EMBODIMENT OF THE INVENTION

The bridge-hub apparatus 1 described in the first embodiment has the filtering function. On the other hand, a bridge-hub apparatus according to a second embodiment does not have the filtering function. A data transferring system according to the second embodiment has the same structure as the data transferring system 100 according to the first embodiment.

FIG. 6 is a diagram for illustrating a schematic layer structure of a bridge-hub apparatus la according to a second embodiment of this invention. The bridge-hub apparatus la shown in FIG. 6 converts data received over the line 60b (not shown) into an ATM cell, and transmits the ATM cell to the telephone central office 71. The bridge-hub apparatus la also receives an ATM cell from the telephone central office 71, extracts IP datagram or a frame from the received ATM cell, and transmits the IP datagram or the frame to the terminal 10a, 10b, . . . , or 10n. Incidentally, the bridge-hub apparatus 1b will be later described in a third embodiment.

The bridge-hub apparatus la does not have the filtering function. The bridge-hub apparatus 1a does not comprise the learning table 2 unlike the bridge-hub apparatus 1 according to the first embodiment. For this, the bridge-hub apparatus 1a is given its own MAC address and IP address by a terminal in the network 20. Namely, the user remotely IP-controls the bridge-hub apparatus la from the terminal 10a, 10b, or 10n, thereby altering a setting relating to units inside the bridge-hub apparatus 1a or information on the apparatus. Switching of the bridge-hub apparatus 1a is performed by the MAC processing unit 12.

For this, the MAC address confirming unit 15a can beforehand read a MAC address of the bridge-hub apparatus 1a. The MAC address of the bridge-hub apparatus la is rewritten according to an instruction under the IP control from the user. When a MAC address included in a received MAC frame agrees with the written MAC address, the MAC frame is transferred to the IP processing unit 13.

An IP address of the bridge-hub apparatus 1a is set in the address setting unit 3. The IP address of the bridge-hub apparatus 1a is rewritten according to an instruction under the IP control. When an IP address included in a transferred frame agrees with this IP address, the frame is transferred to the application processing unit 14.

Accordingly, the bridge-hub apparatus 1a without the filtering function is recognized in the network.

When a terminal 10a, 10b, . . . , or 10n connected to the corresponding port P1, P2, . . . or Pn of the bridge-hub apparatus 1a transmits a MAC frame, the bridge-hub apparatus 1a transmits the received frame to all the ports P2-Pn excepting the receiving port P1 since the bridge-hub apparatus 1a does not have the learning table 2.

As to the other parts, like reference characters designate parts having the same or similar functions, further descriptions of which are thus omitted.

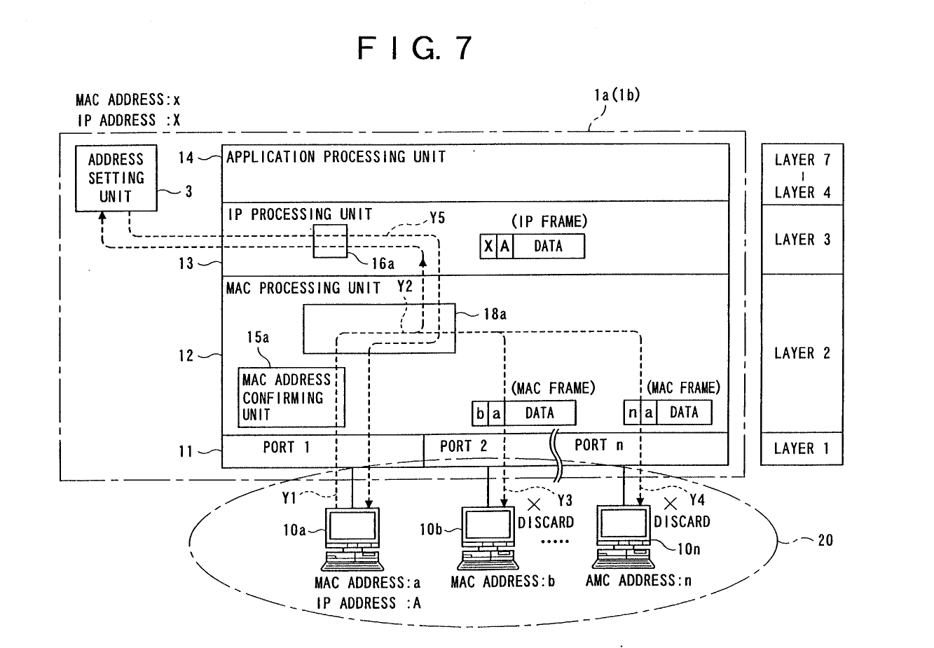

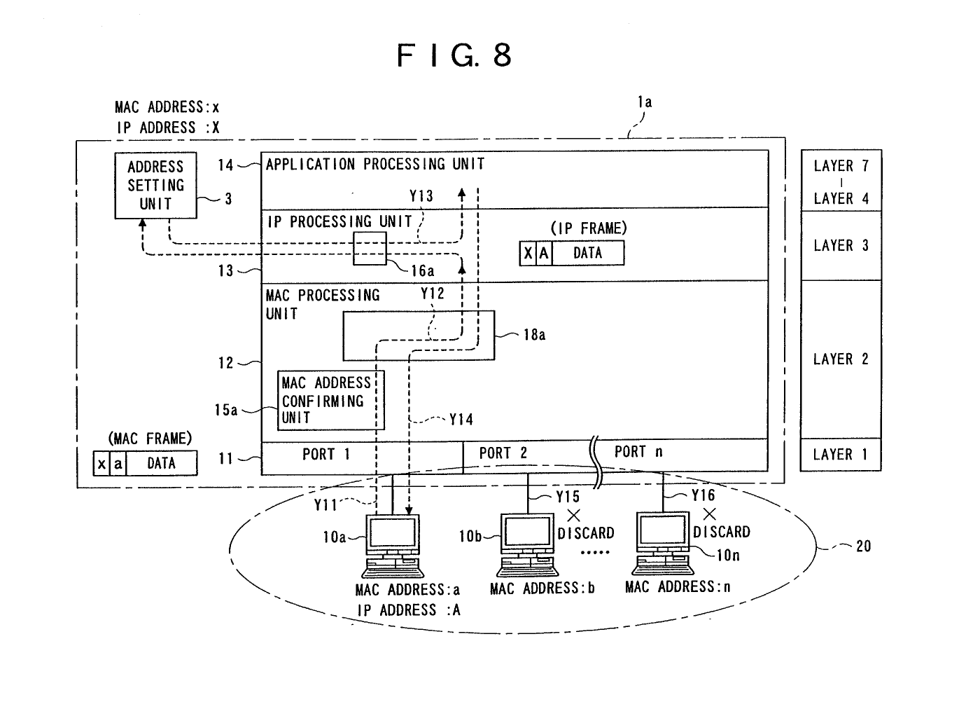

Next, description will be made of ARQ and an operation of the bridge-hub apparatus 1a without the filtering function in the above structure, with reference to FIGS. 7 and 8.

FIG. 7 is a diagram for illustrating the operation at the time of the ARP processing of the bridge-hub apparatus 1a according to the second embodiment of this invention. Incidentally, the bridge-hub apparatus 1b will be described later in the third embodiment.

The terminal 10a transmits an ARQ request frame with the destination MAC address being “broadcast address” and the destination IP address being “X” to the port P1 (message Y1). In the bridge-hub apparatus 1a, the MAC address confirming unit 15a reads out the MAC address of the converted frame. When the MAC address confirming unit 15a recognizes that the MAC address is own MAC address of its bridge-hub apparatus 1a, the MAC address confirming unit 15a transfers the converted frame to only the IP processing unit 13.

When the MAC processing unit recognizes that the received frame is of “broadcast address”, the MAC processing unit 12 transfers the converted frame and the received MAC frame to the IP processing unit 13 and each of the ports P1-Pn (message Y2).

The bridge-hub apparatus 1a beforehand sets an initial value of the IP address of the bridge-hub apparatus 1a in the address setting unit 3. Each of the terminals 10a-10n connected to the respective ports P1-Pn can rewrite the initial value under the IP control. In the case of a local MAC address, own MAC address of the bridge-hub apparatus 1a held in the MAC address confirming unit 15a can be rewritten under the IP control.

Next, control on the bridge-hub apparatus 1a by the terminal 10a will be described.

The terminal 10a shown in FIG. 7 transmits an ARQ request frame, in which an IP address (X) of the bridge-hub apparatus 1a is set as the destination IP address and the broadcast address as the destination MAC address, to the network 20 in order to obtain a MAC address of the bridge-hub apparatus 1a (message Y1).

When a terminal 10a, 10b, . . . , or 10n connected to the corresponding port P1, P2, . . . , or Pn transmits a MAC frame, the bridge-hub apparatus 1a transmits the received frame to all the ports excepting the port P1 for transmission/reception, since the bridge-hub apparatus 1a does not have the learning table 2.

The address confirming unit 15a determines whether the received MAC address is own MAC address of the bridge-hub apparatus 1a or a broadcast address. The address confirming unit 15a then processes as described in (1-1) to (1-3) below.

(1-1) When the received MAC address agrees with the MAC address of the bridge-hub apparatus 1a:

The address confirming unit 15a transfers the converted frame to the IP processing unit, but does not transfer it the other ports P2-Pn (message Y2).

In selective transfer (at a selectively transferring step), when the bridge-hub apparatus 1a recognizes that the received frame is of its own MAC address, the bridge-hub apparatus 1a transfers the converted frame to the upper layer (upper layer transferring step).

(1-2) When the received MAC address agrees with the broadcast address:

The address confirming unit 15a transfers the ARQ request frame received by the port P1 to each of the ports P1-Pn, and also transfers a converted frame of the ARQ request frame to the IP processing unit 13 (messages Y3 and Y4).

In selective transfer (at the selectively transferring step), when the bridge-hub apparatus 1a recognizes that the received frame is of the broadcast MAC address for broadcasting, the bridge-hub apparatus 1a transfers the converted frame to the upper layer, and all the ports P2-Pn excepting the port (receiving port) P1 to which the frame has been inputted among the n ports P1-Pn (upper layer-port transferring step)

(1-3) When the received MAC address agrees with neither the MAC address of the bridge-hub apparatus 1a nor the broadcast address:

The address confirming unit 15a transfers the frame received by the port p1 to the ports P2-Pn. At this time, the address confirming unit 15a does not transfer the frame to the IP processing unit 13.

In selective transfer (at the selectively transferring step), when the bridge-hub apparatus 1a recognizes that the received MAC address is an address other than its own MAC address and the broadcast MAC address, the bridge-hub apparatus 1a transfers the converted frame to the n ports P1-Pn (third transferring step).

The IP processing unit 13 refers to the address setting unit 3 to check whether an IP address of the converted frame agrees with an IP address addressed to the bridge-hub apparatus 1a or not. When these addresses agree with each other, the IP processing unit 13 transfers an ARQ response frame to the terminal 10a to the MAC processing unit 12 (message Y5). When the addresses do not agree, the ARQ response frame is discarded at Layer 2. Thus, the processing can be sped up.

The MAC processing unit 12 sets the own MAC address as the transmission source MAC address, and transmits the ARQ response frame to the terminal 10a. Since the terminal 10a recognizes a MAC address of the bridge-hub apparatus 1 from the transmission source MAC address of the transmitted ARQ response frame, the terminal 10a sets control data for the bridge-hub apparatus 1a in IP datagram, and transmits a MAC frame in which an IP address and a MAC address of the bridge-hub apparatus 1a are set as the destination IP address and the destination MAC address, respectively.

FIG. 8 is a diagram for illustrating an operation at the time of control on the bridge-hub apparatus 1a according to the second embodiment of this invention. When the terminal 10a shown in FIG. 8 transmits a frame to the bridge-hub apparatus 1a (message Y11), the MAC address confirming unit 15a of the bridge-hub apparatus 1a confirms a MAC address included in the frame received by the port P1.

When the MAC address confirming unit 15a recognizes that the MAC address is own MAC address of the bridge-hub apparatus 1a, the MAC address confirming unit 15a transfers the converted frame to the IP processing unit 13 (message Y12).

The IP processing unit refers to the address setting unit 3 to check whether an IP address of the converted frame is a destination IP address of the bridge-hub apparatus 1a or not. When the IP address of the frame agrees with the own IP address, the IP processing unit 13 transfers the frame to the application processing unit 14 (message Y13), in which data included in the frame is processed.

The bridge-hub apparatus 1a checks a MAC address of a frame received by the port P1, and performs any one of three kinds of processing (1-4) to (1-5) below.

(1-4) IP processing unit 13

(1-5) all ports

(1-6) all ports P2-Pn excepting a receiving port P1

With the bridge-hub apparatus 1a, it is possible to provide advantages similar to those provided in the first embodiment.

As above, the bridge-hub apparatus 1a does not have the filtering function. Even when the bridge-hub apparatus 1a does not recognize its own MAC address, the bridge-hub apparatus 1a can control bridging.

### (C) DESCRIPTION OF THIRD EMBODIMENT OF THE INVENTION

According to a third embodiment, the bridge-hub apparatus does not have the filtering function, and both of own MAC address and own IP address are given to the bridge-hub apparatus. A data transferring system according to the third embodiment has the similar structure to the data transferring system according to the first embodiment. The bridge-hub apparatus 1b according to the third embodiment has the similar structure to the bridge-hub apparatus 1a shown in FIG. 6.

The bridge-hub apparatus 1b has neither the filtering function nor the learning table 2. When the bridge-hub apparatus 1b receives a MAC frame from a terminal 10a, 10b, . . . , or 10n connected to a corresponding port P1, P2, . . . , or Pn, the bridge-hub apparatus 1b transfers the received MAC frame to all the ports P2-Pn excepting the port P1 for transmission/reception. Therefore, switching is performed at Layer 2.

In the address setting unit 3, an initial value of the IP address is beforehand set. The IP address can be rewritten by the terminals 10a-10n connected to the respective ports P1-Pn under the IP control.

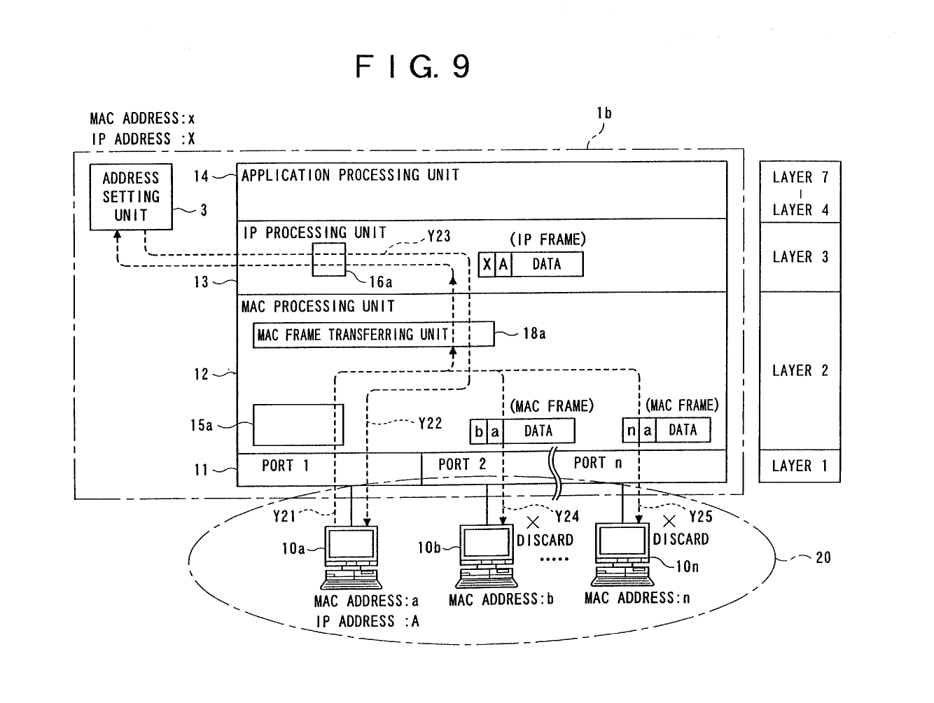

With the above structure, an ARP operation of the bridge-hub apparatus 1b is carried out. Next, control on the bridge-hub apparatus 1b by the terminal 10a will be described with reference to FIG. 9.

FIG. 9 is a diagram for illustrating an operation at the time of the ARP processing of the bridge-hub apparatus 1b according to the third embodiment of this invention. In FIG. 9, like reference characters designate parts having the same or similar functions, further descriptions of which are thus omitted.

In order to obtain a MAC address of the bridge-hub apparatus 1b, the terminal 10a transmits an ARQ request frame, in which an IP address “X” of the bridge-hub apparatus 1b is set as the destination IP address and the broadcast address as the destination MAC address, to the network 20 (message Y21).

When the port P1 receives the ARQ request frame, the MAC frame confirming unit 15a transfers the ARQ request frame received at the port P1 to all the other ports P2-Pn. The transferred frames are discarded in each of the terminals 10b-10n since the destination IP address thereof differs from an IP address of each of the terminals 10b-10n (messages Y24 and Y25).

The MAC frame confirming unit 15a inserts own IP address and own MAC address of the bridge-hub apparatus 1b into the transmission source IP address and the transmission source MAC address of the frame from the IP address confirming unit 16a, and transfers all of them to the IP processing unit 13 (message Y22).

The IP address confirming unit 16a then refers to the address setting unit 3 to determine whether a destination IP address of the converted frame agrees with own IP address of the bridge-hub apparatus 1b or not. When they agree with each other, the IP address confirming unit 16a transfers the ARQ response frame to the terminal to the MAC processing unit 12 (message Y23). When they do not agree, the converted frame is discarded by the IP address confirming unit 16a.

Since the terminal 10a recognizes own MAC address of the bridge-hub apparatus 1b by referring to the transmission source MAC address in the transmitted ARQ response frame, the terminal 10a sets control data for the bridge-hub apparatus 1b in the IP datagram, and transmits a MAC frame, in which an IP address and a MAC address of the bridge-hub apparatus 1b are set as the destination IP address and the destination MAC address, respectively.

According to a transfer controlling method of this invention, when the bridge-hub apparatus 1b selectively transfers a converted frame obtained by converting a received ARQ request frame to a upper layer or the other terminals connected to the network 20 (at a selectively transferring step), the bridge-hub apparatus 1b transmits an ARQ response frame including a MAC address of another terminal to the terminal (protocol responding step).

Whereby, an apparatus setting inside the bridge-hub apparatus 1b or information on the apparatus can be IP-controlled by the terminals 10a-10n in the same network or in a different network 21.

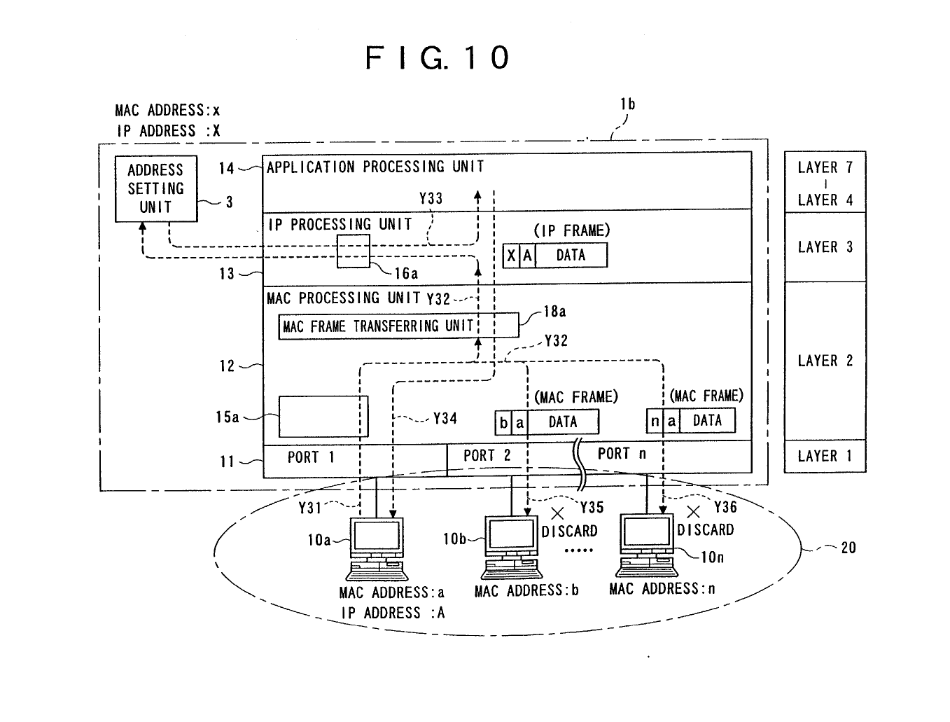

Next, description will be made of a control on the bridge-hub apparatus 1b with reference to FIG. 10.

FIG. 10 is a diagram for illustrating an operation at the time of control on the bridge-hub apparatus 1b according to the third embodiment of this invention. The terminal 10a inserts “x” and “X” to the destination MAC address and the destination IP address, respectively, and transmits a MAC frame (message Y31).

The frame transferring unit 18a transfers the MAC frame received by the port P1 to all the other ports P2-Pn and the IP layer (IP processing unit 13) irrespective of the destination MAC address (message Y32).

The IP processing unit 13 generates an IP frame on the basis of the converted frame, and confirms whether an IP address included in the generated IP frame is the own IP address or not by referring to the address setting unit 3. When the IP processing unit 13 confirms that the received IP address agrees with the own IP address, the IP processing unit 13 transfers the IP frame to the application processing unit 14 (message Y33), and processes the data. The IP processing unit 13 transfers the IP frame from the application processing unit 14 to the MAC processing unit 12, whereby the bridging can be controlled.

When receiving a frame from the IP processing unit 13, the frame transferring unit 18a sets the own IP address and the own MAC address as the transmission source IP address and the transmission source MAC address, and transmits the frame (message Y34). Each of the terminals 10b-10n n discards the frame since the destination MAC address differs from its own MAC address (steps Y35 and Y36).

According to a transfer controlling method of this invention, an ARQ request including an IP address of the bridge-hub apparatus 1b and a broadcast MAC address for broadcasting which is transmitted from a terminal 10a, 10b, . . . , or 10n connected to the network 20 in order to obtain own MAC address representing the bridge-hub apparatus 1b that can transfer a frame is received by the MAC processing unit 12 which transfers the ARQ request frame to the apparatus's side or to the other terminals' side connected to the network 20 (frame receiving step).

The MAC processing unit 12 transfers the ARQ request frame received at the frame receiving step to n ports P1-Pn assigned addresses to discriminate services on the upper layer's side and to the IP processing unit 13 (upper layer) (first frame transferring step).

The upper layer determines whether an IP address in the ARQ request frame is addressed to the bridge-hub apparatus 1b or not by the address setting unit 3 that can hold data (determining step).

When the IP processing unit 13 determines that the IP address is addressed to the bridge-hub apparatus 1b at the determining step, the IP processing unit 13 transfers a notification frame obtained by converting the ARQ request frame to the upper layer (second frame transferring step).

With the bridge-hub apparatus 1b, it is possible to provide similar advantages to those provided by the first embodiment.

As above, each of the terminals 10a-10n in the same network 20 or in a different network 21 can directly set the bridge-hub apparatus 1b, so that it becomes unnecessary for the user to individually switch the bridge-hub apparatus 1b or set a control by the terminal 10a, 10b, . . . , or 10n.

Layer 2 can speed up switching of the bridge-hub apparatus 1b with respect to the bridging function.

### (C1) DESCRIPTION OF FIRST MODIFICATION OF THIRD EMBODIMENT OF THE INVENTION

According to a first modification of the third embodiment and a second modification of the same to be described later, units for masking frames to the terminals 10a-10n is added to the bridge-hub apparatus 1b according to the third embodiment. The data transferring system according to the first modification has the similar structure to the data transferring system 100 according to the first embodiment.

FIG. 11 is a diagram for illustrating a schematic layer structure of a bridge-hub apparatus 1c according to the first modification of the third embodiment of this invention. The bridge-hub apparatus 1c shown in FIG. 11 converts data received over the line 60b (refer to FIG. 1) into an ATM cell, and transmits the ATM cell to the telephone central office 71. The bridge-hub apparatus 1c, on the other hand, receives an ATM cell from the telephone central office 71, extracts IP datagram or a frame from the received ATM cell, and transmits it to the terminal 10a, 10b, . . . , or 10n. The bridge-hub apparatus 1c does not have the filtering function, and is given both own MAC address and own IP address. The bridge-hub apparatus 1c can be thereby discriminated in the network 20.

The sub MAC processing unit 112a of the MAC processing unit 12 transfers a received frame from the port P1 to the IP processing unit 13 or to the other sub MAC processing units 12b-12n. The sub MAC processing unit 112a, on the other hand, outputs a frame transferred from the IP processing unit 13 or from another sub MAC processing unit 12b, 12c, . . . , or 12n to the port P1. Each of the sub MAC processing unit 112b-112n is similar to the sub MAC processing unit 112a. The sub MAC processing units 112a-112n have mask processing units 23a-23n, respectively.

Each of the mask processing units 23a-23n limits input and output of a frame at the transmitting/receiving unit 11 on the basis of an agreement signal outputted from the address setting unit 3. The agreement signal is a signal representing agreement or disagreement between a first IP address and own IP address presenting the apparatus itself, which is inputted from the address setting unit 3 to each of the mask processing unit 23a-23n. A control signal (denoted by a broken line) is inputted from the address setting unit 3 to each of the mask processing units 23a-23n.

Each of the mask processing units 23a-23n functions as a MAC frame transmitting unit which can transmit a MAC frame. This function is accomplished by, for example, a CPU, a ROM, a RAM, an IC (Integrated Circuit) and the like.

The IP address confirming unit 16a compares an address of the assembled IP datagram with own IP address. When the addresses disagree, the IP address confirming unit 16a transfers an address disagreement signal to the mask processing unit 23a. The mask processing unit 23a does not immediately transfer the received MAC frame to the ports P1-Pn.

In concrete, if an ARQ request frame is received by the port P1, the mask processing unit 23a does not transfer the ARQ request frame to all the ports P2-Pn excepting the receiving port P1 when receiving an address agreement signal from the address setting unit 3. When receiving an address disagreement signal from the address setting unit 3, the mask processing unit 23a transfers the ARQ request frame to all the ports P2-Pn excepting the port P1.

Namely, the IP processing unit 13 outputs an agreement signal using the address setting unit 3, and the mask processing unit 23a masks a frame to be transmitted when receiving an agreement signal along with the frame from the sub IP processing unit 13a.

By means of the agreement signal, the IP processing unit 13 and the MAC processing unit 12 can manage output data in cooperation, so that the bridge-hub apparatus 1c can certainly transfer it.

The frame transferring unit 18a transfers every MAC frame received by the ports P1-Pn of the bridge-hub apparatus 1c to the IP processing unit 13. For this, the bridge-hub apparatus 1c does not recognize its own MAC address.

In the address setting unit 3, an IP address of the bridge-hub apparatus 1c is set. An IP frame agreeing with this IP address is transferred to the application processing unit 14. When the IP address agrees with the IP address of the mask processing unit 23a, 23b, . . . , or 23n, the IP processing unit 13 outputs an address agreement signal. When the IP address does not agree, the IP processing unit 13 outputs an address disagreement signal. The address setting unit 3 rewrites the IP address of the bridge-hub apparatus 1c according to an instruction under the IP control.

Next, control on the bridge-hub apparatus 1c in the above structure by the terminal 10a will be described.

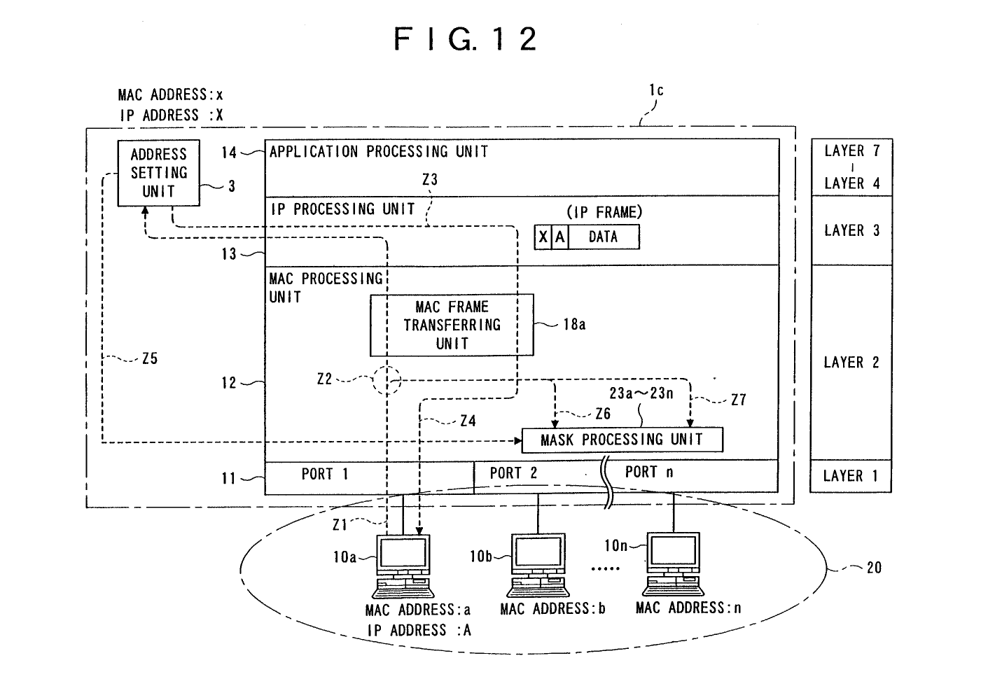

FIG. 12 is a diagrams for illustrating an operation of a transfer controlling function of the bridge-hub apparatus 1c according to the first modification of the third embodiment of this invention. An operation of the bridge-hub apparatus 1c shown in FIG. 12 is performed for each frame.

In order to obtain a MAC address of the bridge-hub apparatus 1c, the terminal 10a sets an IP address “X” of the bridge-hub apparatus 1c and the broadcast address as the destination IP address and the destination MAC address, respectively, included in an ARQ request frame, and transmits the ARQ request frame to the network.

The terminal 10a then transmits a MAC frame in which these two kinds of addresses have been inserted (message Z1). The frame transferring unit 18a transfers the MAC frame received by the port P1 to all the other ports P2-Pn and to the IP processing unit 13 irrespective of a value (display) of the destination MAC address (message Z2). The bridge-hub apparatus 1c transfers every MAC frame received by the port P1 to the mask processing units 23a-23n, and to the IP processing unit 13.

The IP processing unit 13 refers to the address setting unit 3 to confirm whether the IP address is the own IP address or not. When the addresses agree with each other, the IP processing unit 13 transfers the converted frame to the application processing unit 14 to make the application processing unit 14 process the data, and transfers an ARQ response frame to be transmitted to the terminal 10a to the MAC processing unit 12 (message Z3). The IP processing unit 13 outputs an address agreement signal to the mask processing units 23a-23n (message Z5).

Whereby, transfer of the MAC frame to all the ports P2-Pn excepting the port P1 having received the MAC frame is masked in the mask processing units 23a-23n. When receiving an address agreement signal, each of the mask processing units 23a-23n does not transfer the ARQ response frame to all the ports P2-Pn excepting the port P1.

When receiving an address disagreement signal from the address setting unit 3 (message Z5), the mask processing units 23a-23n transfer the ARQ request frame to all the ports P2-Pn excepting the port P1 having received the MAC frame (messages Z6 and Z7).

The MAC processing unit 12 sets the own MAC address as the transmission source MAC address in the ARQ response frame to be transmitted to the terminal 10a (message Z4), and transmits it to the terminal 10a. The terminal 10a recognizes a MAC address of the bridge-hub apparatus 1c from the transmission source MAC address of the transmitted ARQ response frame. Thus, the terminal sets control data of the bridge-hub apparatus 1c in IP datagram, and sets an IP address and a MAC address of the bridge-hub apparatus 1c as the destination IP address and the destination MAC address in a MAC frame, and transmits it.

According to a transfer controlling method of this invention, the upper layer transmits an agreement signal representing agreement or disagreement between a first IP address and another IP address representing another terminal connected to the network to the MAC processing unit 12 on the basis of an ARQ request frame transmitted at a frame receiving step (agreement signal transmitting step).

The MAC processing unit 12 then limits output of a frame from the port P1 on the basis of the agreement signal transmitted at the agreement signal transmitting step (output limiting step).

Whereby, control on bridging becomes possible. Additionally, the traffic can be decreased since transmission of an unnecessary frame is masked.

The transfer controlling method according to this invention is applied to a bridge-hub apparatus 1c which has n ports P1-Pn assigned respective port numbers to discriminate services on the upper layer's side, through each of which a frame including a MAC address for discriminating a corresponding terminal 10a, 10b, . . . , or 10n connected to a network 20 is inputted, the bridge-hub apparatus having the bridging function of outputting a frame including own MAC address representing a terminal apparatus that can transfer a frame to a port P1, P2, . . . , or Pn corresponding to the own MAC address, and the hub function of outputting a received frame from one port P1 to all the other ports P2-Pn.

The MAC processing unit 12 holds MAC addresses of the terminals 10a-10n connected to n ports P1-Pn, respectively (holding step).

The terminal 10a connected to the receiving port P1 through which a frame is inputted among the n ports P1-Pn limits output of the frame (frame transmission) from masked ports P2-Pn among the n ports P1-Pn under a control of the upper layer (output limiting step).

The bridge-hub apparatus 1c is given a MAC address and an IP address, so that bridging and routing become possible. Accordingly, it is possible to provide advantages similar to those provided in the first embodiment.

The bridge-hub apparatus 1c exhibits the bridging function and the routing function, so that the carrier can continue the operation of the system without largely changing existing installation or system specifications even if the network relating apparatuses are varied in the future.

Since the MAC processing unit 12 distributes the own MAC address, an apparatus setting inside the apparatus of or apparatus information on the bridge-hub apparatus 1c can be IP-controlled by the terminal 10a in the same network or in a different network 21. Additionally, switching inside the apparatus can be done at Layer 2.

### (C2) DESCRIPTION OF SECOND MODIFICATION OF THIRD EMBODIMENT OF THE INVENTION

A bridge-hub apparatus according to a second modification is similar to the bridge-hub apparatus 1c shown in FIG. 11. A data transferring system according to the second modification has a similar structure to that of the data transferring system 100 according to the first embodiment.

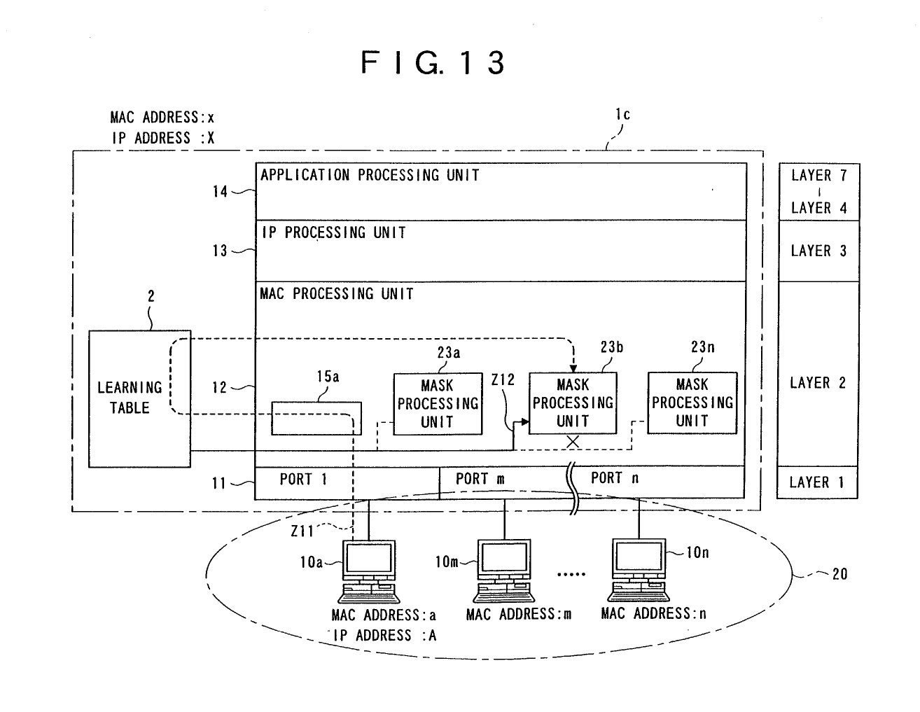

FIG. 13 is a diagram for illustrating an operation of a bridge-hub apparatus 1c according to the second modification of the third embodiment of this invention. The bridge-hub apparatus 1c shown in FIG. 13 does not have the filtering function. The network 20 shown in FIG. 13 has a terminal 10m at which a MAC address “m” (m is a natural number not less than one) is set. The terminal 10m is similar to each of the terminals 10a-10n, detailed description of which is thus omitted. In FIG. 13, like reference characters designate parts having the same or similar functions, further descriptions of which are thus omitted.

A mask processing unit 23m having a similar function to that of the mask processing unit 23a is connected to a port Pm. Each of the mask processing units 23a-23n masks a MAC frame to be outputted to the port P1, P2, . . . , or Pn by a control signal received from the learning table 2. A MAC address held in the bridge-hub apparatus 1c can be rewritten according to an instruction from the user under the IP control.

The learning table 2 records a MAC address of each of the terminals 10a-10n connected to the respective ports P1-Pn of the bridge-hub apparatus 1c from a transmission source MAC address of a frame transmitted from the port P1. A frame is transferred to each of the ports P1-Pn according to the learning table 2.

The learning table 2 has a mask setting control function from each of the ports P1-Pn. When a destination address of a received MAC frame agrees with a MAC address of a port at which masking is set, the learning table transmits a control signal to the mask processing unit 23a, 23b, . . . , or 23n. The learning table 2 can be rewritten under the IP control from the outside.

With the above structure, the masking is set to each of the ports P1-Pn in the learning table 2 inside the apparatus under the IP control from a control port of the apparatus or from the terminals 10a-10n connected to the respective ports P1-Pn in the bridge-hub apparatus 1c.

The terminal 10a inserts “m” to the destination MAC address, and transmits data to the bridge-hub apparatus 1c (message Z11).

The mask processing unit 23b masks a frame to be transmitted from the port P1, P2, . . . , or Pn by a control signal (message Z12) from the learning table 2.

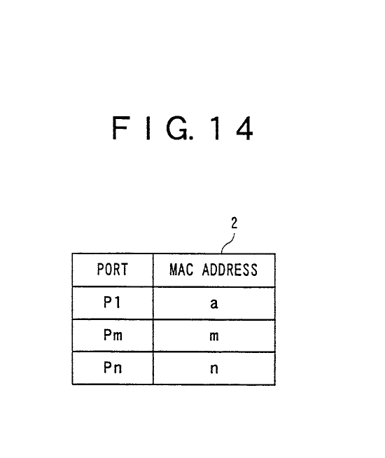

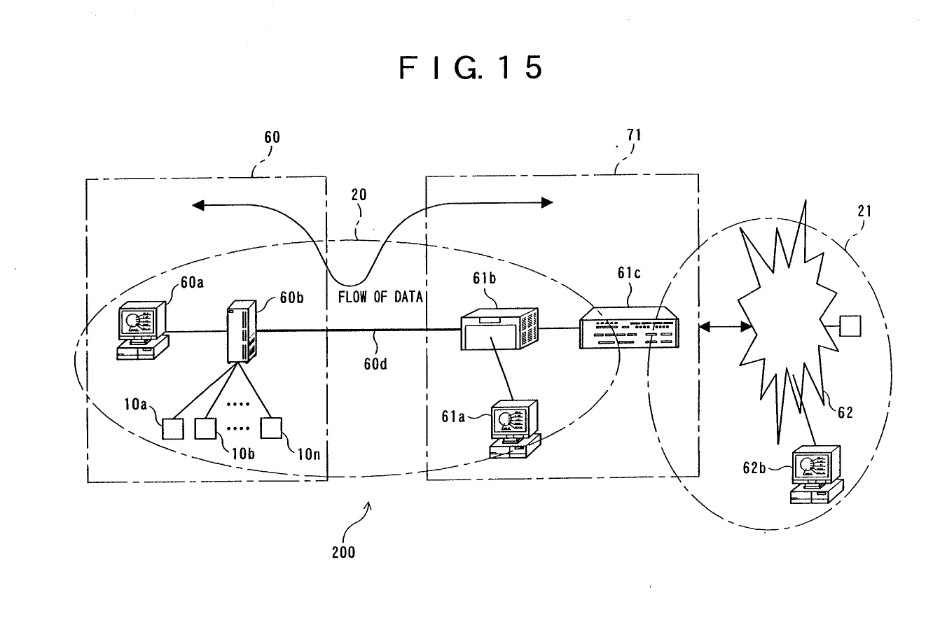

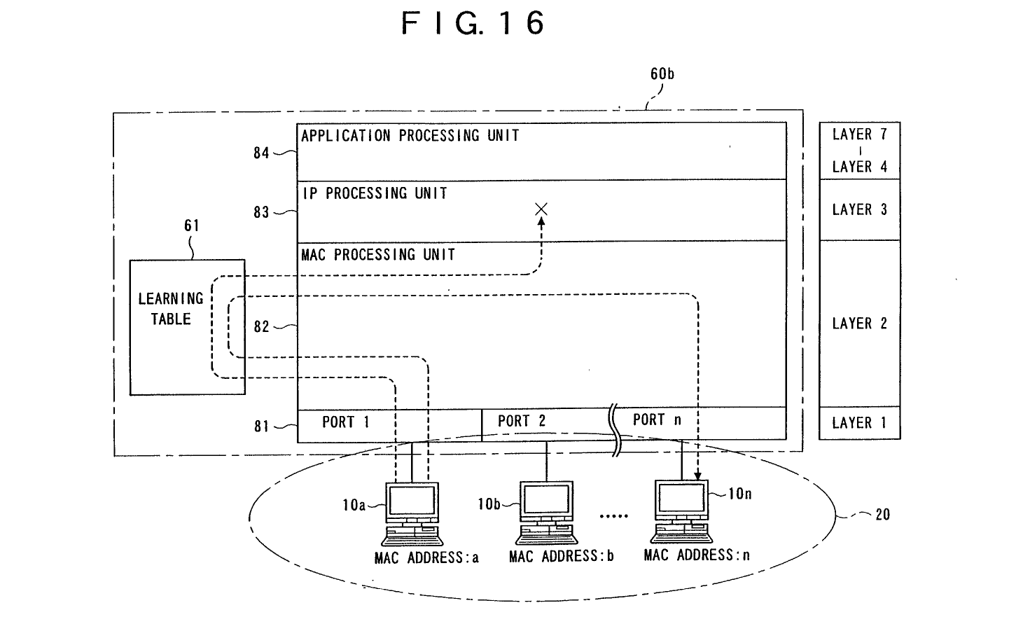

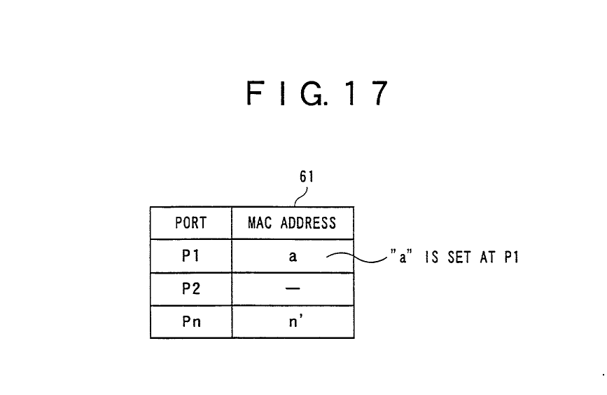

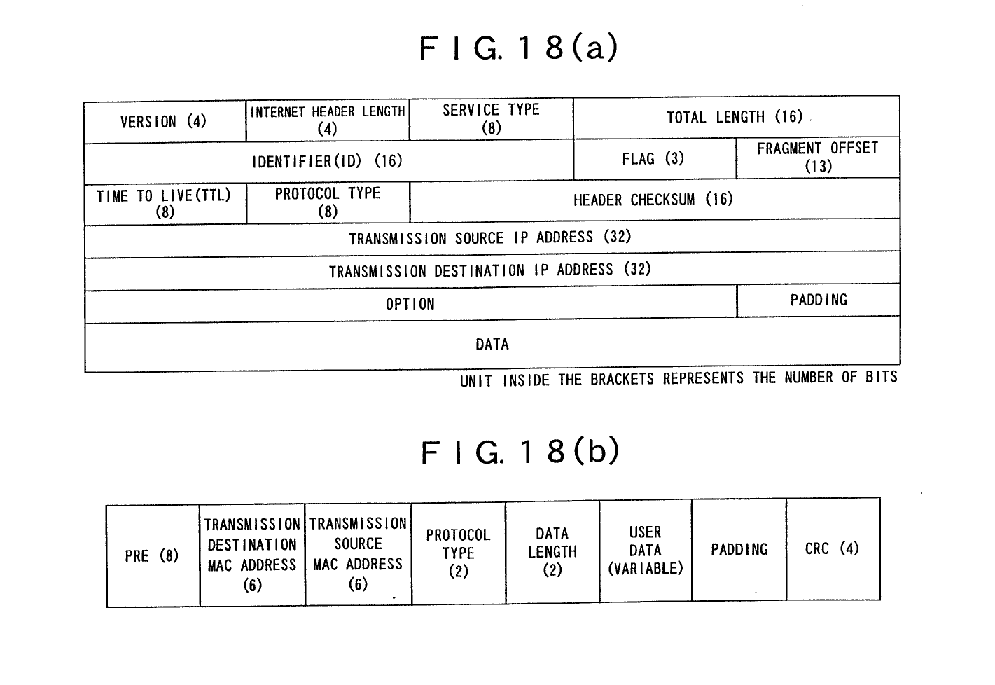

FIG. 14 is a diagram for illustrating the learning table 2 according to the second modification of the third embodiment of this invention. The learning table 2 shown in FIG. 14 gives a mask instruction to a port Pm having a port number m under the IP control from the control port of the bridge-hub apparatus 1c or from the terminal 10a, 10b, . . . , or 10n connected to the port P1, P2, . . . , or Pn.

When the learning table 2 is in the initial state or when the destination address is the broadcast address like an ARQ request frame, for example, the frame is transferred to each of the ports P1-Pn of the apparatus. Next, a case where the bridge-hub apparatus 1c controls masking of frame transmission to the terminal 10m will be described.

Under the IP control from the control port of the bridge-hub apparatus 1c or from the terminal 10a, 10b, . . . , or 10n connected to the port P1, P2, . . . , or Pn, masking is set to a received frame to the port Pm. From a transmission source address of a frame transmitted from the terminal 10m connected to the port m, the learning table 2 records “m” as the MAC address of the terminal 10m.

When the terminal 10m transmits a frame to the terminal 10a, the bridge-hub apparatus 1c confirms a destination address of the received frame, and searches for a port to which the frame should be transmitted in the learning table 2. When the bridge-hub apparatus 1c recognizes that a port to which the frame should be transmitted is the port Pm at which the masking is set, the bridge-hub apparatus 1c transmits a control signal to the mask processing unit 23m of the port Pm. When receiving the control signal, the mask processing unit 23m does not transmit the frame, but discards it.

Layer 2 switches the apparatus as above, it is possible to provide the similar advantages to those provided by the first embodiment. In addition, since Layer 2 masks a designated port to limit transmission of a frame from the port, it is possible to speed up the switching.

### (D) OTHERS

The present invention is not limited to the above examples, but may be modified in various ways without departing from the scope of the invention.

The above transfer controlling method is applied to ARP, but the present invention can be also applied to RARP (Reverse Address Resolution Protocol).

The above specific terminal apparatus may be a terminal or apparatus connected to the network 20 or 21 other than the bridge-hub apparatus 1 (1a-1c). Instead of the above bridge-hub apparatus 1 (1a-1c), a single apparatus such as a bridging apparatus or a hub apparatus may be employed.

The MAC frame may be processed using priority. The discriminate sign for discriminating a service on the upper layer's side may be a unique number, for example, other than a port number.

The MAC processing unit 12, the IP processing unit 13, and the application processing unit 14 are provided for each of the n ports. However, these units may be designed as a single unit. A difference in design between these does not at all suffer the superiority of the present invention.

Each of the terminals 10a-10n may have a radio transceiver.

1. A transferring apparatus comprising:
a transmitting/receiving unit for inputting/outputting a frame including first lower identification data by which a terminal connected to a network can be identified;
a lower identification data holding unit for holding specific lower identification data of a specific terminal apparatus connected to said network; and
a lower layer frame processing unit for transferring said frame to either its own apparatus's side or other terminals' side connected to said network on the basis of said first lower identification data and said specific lower identification data.

2. The transferring apparatus according to claim 1, wherein said lower identification data holding unit holds own lower identification data representing said apparatus itself as said specific lower identification data; and
said lower layer frame processing unit transfers said frame to said own apparatus's side when said first lower identification data agrees with said own lower identification data, while transferring said frame to said other terminals'side when said lower identification data does not agree with said own lower identification data.

3. The transferring apparatus according to claim 2, wherein said transmitting/receiving unit comprises a plurality of ports to each of which an identification sign for identifying a service on a upper layer's side is assigned.

4. The transferring apparatus according to claim 3, wherein said lower layer frame processing unit comprises:
a lower identification data recognizing unit for recognizing that said received frame is said own lower identification data on the basis of said first lower identification data and said own lower identification data; and
a frame transferring unit for transferring a converted frame generated from said received frame to a upper layer's side when said lower identification data recognizing unit recognizes that said own lower identification data is said own lower identification data.

5. The transferring apparatus according to claim 4, wherein said lower identification data holding unit relates an identification sign assigned to each of said plural ports with another lower identification data representing another terminal, and holding said identification sign and said another lower identification data.

6. The transferring apparatus according to claim 4, wherein at least either said lower identification data recognizing unit or said frame transferring unit of said lower layer frame processing unit processes for each of said plural ports.

7. The transferring apparatus according to claim 4 further comprising:
a upper layer frame processing unit for generating first upper identification data on the basis of said converted frame transferred by said lower layer frame processing unit, and being able to output an agreement signal representing agreement or disagreement between said first upper identification data and own upper identification data representing said apparatus itself.

8. The transferring apparatus according to claim 7, wherein said transferring apparatus uses a upper identification data holding unit which is connected to said upper layer frame processing unit to hold said own upper identification data to output said agreement signal.

9. The transferring apparatus according to claim 8, wherein said lower layer frame processing unit comprises a mask processing unit for limiting input and output of a frame at said transmitting/receiving unit on the basis of said agreement signal outputted from said upper identification data holding unit.

10. The transferring apparatus according to claim 3, wherein said lower layer frame processing unit comprises:
a lower identification data recognizing unit for recognizing that said received frame is broadcast lower identification data for broadcasting on the basis of said first lower identification data and said broadcast lower identification data for broadcasting; and
a frame transferring unit for transferring a converted frame generated from said received frame to a upper layer's side and other ports different from a receiving port to which said received frame has been inputted among said plural ports.

11. The transferring apparatus according to claim 10, wherein at least either said lower identification data recognizing unit or said frame transferring unit of said lower layer frame processing unit processes each of said plural ports.

12. The transferring apparatus according to claim 10 further comprising:
a upper layer frame processing unit for generating first upper identification data on the basis of said converted frame transferred by said lower layer frame processing unit, and being able to output an agreement signal representing agreement or disagreement between said first upper identification data and own upper identification data representing said apparatus itself.

13. The transferring apparatus according to claim 12, wherein said transferring apparatus uses a upper identification data holding unit which is connected to said upper layer frame processing unit to hold said own upper identification data to output said agreement signal.

14. The transferring apparatus according to claim 13, wherein said lower layer frame processing unit comprises a mask processing unit for limiting input and output of a frame in said transmitting/receiving unit on the basis of said agreement signal outputted from said upper identification data holding unit.

15. A transfer controlling method comprising the steps of:
a request frame receiving step of receiving a predetermined request frame including at least either upper identification data of a specific terminal apparatus or broadcast lower identification data for broadcasting transmitted from a terminal connected to a network in order to obtain specific lower identification data of said specific terminal apparatus which can transfer a frame by a lower layer frame processing unit which transfers said predetermined request frame to either the apparatus's side or the other terminals'side connected to said network; and
a selectively transferring step of selectively transferring a converted frame generated from said request frame received at said request frame receiving step from said terminal apparatus to at least either a upper layer or said other terminals.

16. The transfer controlling method according to claim 15, wherein said selectively transferring step comprises:
a upper layer transferring step of generating first upper identification data on the basis of said converted frame transferred by said lower layer frame processing unit when said transferring apparatus recognizes said own lower identification data, and transferring said converted frame to a upper layer frame processing unit which can output an agreement signal representing agreement or disagreement between said first upper identification data and own upper identification data representing said apparatus itself;
a determining step of determining by said upper layer frame processing unit whether upper identification data of said converted frame transferred at said upper layer transferring step is said own upper identification data or not; and
a responding step of transferring a response frame including own lower identification data corresponding to said own upper identification data to said other terminals from said upper layer frame processing unit when upper identification data of said converted frame is determined as said own upper identification data at said determining step.

17. The transfer controlling method according to claim 16 further comprising the step of:
a upper layer transferring step of transferring said response frame to said upper layer from said upper layer frame processing unit when said upper identification data of said converted frame is determined as said own upper identification data at said determining step.

18. The transfer controlling method according to claim 15, wherein said selectively transferring step comprises:
a upper layer-port transferring step of transferring said converted frame to said upper layer and other ports different from a receiving port to which said request frame has been inputted among said plural ports when said transferring apparatus recognizes broadcast lower identification data for broadcasting.

19. The transfer controlling method according to claim 15, wherein said selectively transferring step comprises:
a third transferring step of transferring said converted frame to said plural ports when said transferring apparatus recognizes identification data other than own lower identification data and said broadcast lower identification data.

20. The transfer controlling method according to claim 15, wherein said selectively transferring step comprises:
a upper layer transferring step of transferring said converted frame to said upper layer when said transferring apparatus recognizes own lower identification data.

21. The transfer controlling method according to claim 15, wherein said selectively transferring step comprises:
a protocol responding step of transmitting a response frame including lower identification data of said other terminal from said transferring apparatus to said other terminal.

22. A transfer controlling method comprising the steps of:
a frame receiving step of receiving a predetermined request frame including upper identification data of a transferring apparatus and broadcast lower identification data for broadcasting transmitted from a terminal connected to a network in order to obtain own lower identification data representing a terminal apparatus which can transfer a frame by a lower layer frame processing unit which transfers said predetermined request frame to either own apparatus's side or other terminals'side connected to said network;
a first frame transferring step of transferring said request frame received at said frame receiving step to at least either ports assigned identification signs for identifying services on the upper layer's side or a upper layer from said lower layer frame processing unit;
a determining step of determining whether upper identification data of said request frame is addressed to said transferring apparatus by said upper layer using a upper layer identification data holding unit which can hold data; and
a second frame transferring step of transferring a notification frame generated from said request frame to a upper layer when said upper layer frame processing unit determines said transferring apparatus at said determining step.

23. The transfer controlling method according to claim 22 further comprising:
an agreement signal transmitting step of transmitting an agreement signal representing agreement or disagreement between said first upper identification data and another upper identification data representing another terminal connected to said network to said lower layer frame processing unit from said upper layer on the basis of said request frame transmitted at said frame receiving step; and
an output limiting step of limiting output of a frame from said port by said lower layer frame processing unit on the basis of said agreement signal transmitted at said agreement signal transmitting step.

24. A transfer controlling method for use in an apparatus to which a frame including lower identification data by which a terminal connected to a network can be identified is inputted through each of a plurality of ports assigned identification signs for identifying services on a upper layer's side, said apparatus having a first function of outputting a frame including own lower identification data representing a terminal apparatus which can transfer a frame to a port corresponding to own lower identification data among said plural ports, and a second function of outputting a received frame from a receiving port to all the other ports among said plural ports, said transfer controlling method comprising the steps of:
a holding step of holding lower identification data of said terminals connected to said respective plural ports; and
an output limiting step of limiting output of a frame through a masked port among said plural ports by a terminal connected to said receiving port to which said received frame has been inputted among said plural ports under a control of a upper layer.
